(19) United States
(12) Patent Application Publication
(10) Pub. No.: US 2017/0228606 A1
(43) Pub. Date: Aug. 10, 2017

(54) INFORMATION PROCESSING APPARATUS, INFORMATION PROCESSING METHOD, AND RECORDING MEDIUM

(71) Applicant: Haike GUAN, Kanagawa (JP)

(72) Inventor: Haike GUAN, Kanagawa (JP)

(21) Appl. No.: 15/420,565

(22) Filed: Jan. 31, 2017

(30) Foreign Application Priority Data
Feb. 9, 2016 (JP) 2016-023052
Apr. 18, 2016 (JP) 2016-082921

(51) Int. Cl. G06K 9/00; B60K 35/00; B60R 11/04; G06T 7/90; B60R 1/00

(52) U.S. Cl. CPC G06K 9/00825; G06T 7/90; B60R 1/00; B60R 11/04; B60K 35/00; B60R 2011/0003

(57) ABSTRACT

An information processing apparatus includes: an image acquiring unit configured to acquire a captured image; a time zone determining unit configured to determine an image capturing time zone of the captured image; and a detecting unit configured to detect, based on the determined image capturing time zone, a traffic light region of a traffic light in the captured image and a traffic light color indicated by the traffic light.

### CROSS-REFERENCE TO RELATED APPLICATIONS

The present application claims priority under 35 U.S.C. §119 to Japanese Patent Application No. 2016-023052, filed Feb. 9, 2016 and Japanese Patent Application No. 2016-082921, filed Apr. 18, 2016. The contents of which are incorporated herein by reference in their entirety.

### BACKGROUND OF THE INVENTION

1. Field of the Invention

The present invention relates to an information processing apparatus, an information processing method, and a recording medium.

2. Description of the Related Art

Systems have been known, which assist drivers by: analyzing captured images captured by image capturing devices, such as in-vehicle cameras; and detecting traffic light colors indicated by traffic lights included in the captured images. Further, apparatuses for detecting traffic light colors indicated by traffic lights in order to recognize the traffic lights have been known. Due to differences between image capturing times, such as the daytime and the nighttime, a captured image, in which light quantity in a portion thereof indicating a traffic light color (a lit portion) is saturated, is sometimes acquired. In this case, detection accuracy for the traffic light region and the traffic light color is reduced. Techniques for avoiding such a problem have thus been developed.

For example, in Japanese Unexamined Patent Application Publication No. 2009-244946, a method is disclosed, which is for detecting a traffic light color by: acquiring two captured images by adjustment of gain of a camera twice; and using these two captured images. According to the above mentioned publication, using the captured image acquired in the first image capturing, the gain for the second image capturing is adjusted.

However, the comparative technique has required plural captured images with different gains. Further, due to an error in the gain adjustment, the detection accuracy has sometimes been reduced significantly. Furthermore, since the position of the traffic light in the captured images is unknown in a state before the detection of the traffic light region, setting the gain enabling accurate detection of the traffic light color has been difficult. That is, in the comparative technique, it has been difficult to accurately detect traffic light colors indicated by traffic lights and traffic light regions included in captured images regardless of the image capturing times of the captured images.

### SUMMARY OF THE INVENTION

According to one aspect of the present invention, an information processing apparatus includes an image acquiring unit, a time zone determining unit, and a detecting unit. An image acquiring unit is configured to acquire a captured image. A time zone determining unit is configured to determine an image capturing time zone of the captured image. A detecting unit is configured to detect, based on the determined image capturing time zone, a traffic light region of a traffic light in the captured image and a traffic light color indicated by the traffic light.

### BRIEF DESCRIPTION OF THE DRAWINGS

FIG. 1 is an explanatory view for an example of an information processing apparatus;

FIG. 2 is a block diagram illustrating an example of a functional configuration of the information processing apparatus;

FIG. 3 is a schematic view illustrating an example of a captured image;

FIG. 4 is a graph illustrating an example of sample points represented by average brightnesses and small brightness block numbers in reference captured images;

FIG. 5 is a schematic diagram illustrating an example of a data configuration of a traffic light recognition dictionary DB;

FIG. 6 is a view illustrating an example of a captured image;

FIG. 7 is a view illustrating an example of a captured image;

FIG. 8 is a graph illustrating an example of a distribution of (U, V) values represented by a green light recognition dictionary for a daytime image capturing time zone;

FIG. 9 is a graph illustrating an example of a distribution of (U, V) values represented by a green light recognition dictionary for a nighttime image capturing time zone;

FIG. 10 is an explanatory view for an example of a detection process for a traffic light region and a traffic light color when the image capturing time zone represents the daytime;

FIG. 11 is an explanatory view for the example of the detection process for the traffic light region and the traffic light color when the image capturing time zone represents the daytime;

FIG. 12 is an explanatory view for the example of the detection process for the traffic light region and the traffic light color when the image capturing time zone represents the daytime;

FIG. 13 is an explanatory view for the example of the detection process for the traffic light region and the traffic light color when the image capturing time zone represents the daytime;

FIG. 14 is an explanatory view for the example of the detection process for the traffic light region and the traffic light color when the image capturing time zone represents the daytime;

FIG. 15 is an explanatory view for an example of a detection process for a traffic light region and a traffic light color when the image capturing time zone represents the nighttime;

FIG. 16 is an explanatory view for the example of the detection process for the traffic light region and the traffic light color when the image capturing time zone represents the nighttime;

FIG. 17 is an explanatory view for the example of the detection process for the traffic light region and the traffic light color when the image capturing time zone represents the nighttime;

FIG. 18 is an explanatory view for the example of the detection process for the traffic light region and the traffic light color when the image capturing time zone represents the nighttime;

FIG. 19 is a flow chart illustrating an example of a procedure of information processing executed by the information processing apparatus;

FIG. 20 is a flow chart illustrating an example of a procedure of an image capturing time zone determination process;

FIG. 21 is a flow chart illustrating an example of a procedure of the detection process;

FIG. 22 is a block diagram illustrating an example of a functional configuration of an information processing apparatus;

FIG. 23 is an explanatory view for an example of a detection process executed by a detecting unit;

FIG. 24 is an explanatory view for the example of the detection process executed by the detecting unit;

FIG. 25 is an explanatory view for the example of the detection process executed by the detecting unit;

FIG. 26 is a flow chart illustrating an example of a procedure of the detection process;

FIG. 27 is a block diagram illustrating an example of a functional configuration of an information processing apparatus;

FIG. 28 is an explanatory view for an example of a recognition process;

FIG. 29 is an explanatory view for the example of the recognition process;

FIG. 30 is a flow chart illustrating an example of a procedure of a detection process;

FIG. 31 is a diagram illustrating an example of a list of image capturing environments in a modification;

FIG. 32 is a flow chart illustrating an example of a flow of a traffic light recognition process in the modification;

FIG. 33 is a diagram illustrating an example of a hardware configuration of an image capturing device; and

FIG. 34 is a block diagram illustrating a hardware configuration of the information processing apparatuses.

The accompanying drawings are intended to depict exemplary embodiments of the present invention and should not be interpreted to limit the scope thereof. Identical or similar reference numerals designate identical or similar components throughout the various drawings.

### DESCRIPTION OF THE EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Hereinafter, by reference to the appended drawings, embodiments of an information processing apparatus, an information processing method, and a recording medium will be described in detail.

An embodiment has an object to provide an information processing apparatus, an information processing method, and a recording medium which enable a traffic light region and a traffic light color of a traffic light to be accurately detected from a captured image.

### First Embodiment

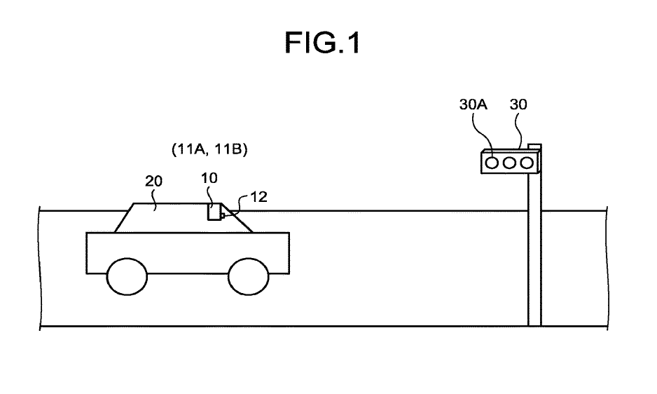

FIG. 1 is an explanatory view for an example of an information processing apparatus 10 of this embodiment. The information processing apparatus 10 is, for example, mounted on a moving body. The moving body is an object that is positionally movable in a real space, by autonomously traveling, traction, or the like. The moving body is, for example, a vehicle, an airplane, a train, or a cart. In this embodiment, a case where the moving body is a vehicle 20 will be described as an example. That is, in this embodiment, a mode where the information processing apparatus 10 has been installed in the vehicle 20 will be described as an example.

An image capturing device 12 is installed in the vehicle 20. The image capturing device 12 acquires a captured image, in which surroundings of the vehicle 20 are captured. The image capturing device 12 is, for example, a known video camera or digital camera. In this embodiment, the image capturing device 12 is able to capture plural captured images (that is, plural frames) by consecutively capturing images of the surroundings of the vehicle 20. The image capturing device 12 may be integrally formed with the information processing apparatus 10, or may be formed as a body separate from the information processing apparatus 10.

Further, the image capturing device 12 is not limited to the mode of being installed in the vehicle 20. The image capturing device 12 just needs to be installed at a position where the image capturing device 12 is able to capture an image of a traffic light 30, and may be fixed to the ground. If a detection result detected by the information processing apparatus 10 of this embodiment is used in assisting a driver of the vehicle 20 with driving, the image capturing device 12 is preferably in the mode of being installed in the vehicle 20.

In this embodiment, the image capturing device 12 has an automatic gain control (AGC) function installed therein. Thus, the image capturing device 12 automatically adjusts its sensitivity, and acquires a captured image, in which brightness of the whole screen of the captured image is automatically adjusted to be optimum.

The information processing apparatus 10 analyzes the captured image. The information processing apparatus 10 detects a light 30A indicated by the traffic light 30 included in the captured image. Detecting the light 30A means detecting a traffic light color indicated by the traffic light 30, and a traffic light region. The traffic light color is a color of a portion (the light 30A in FIG. 1) that is lit up in the traffic light 30. Further, the traffic light region of the light 30A is a region that is lit up in the traffic light 30.

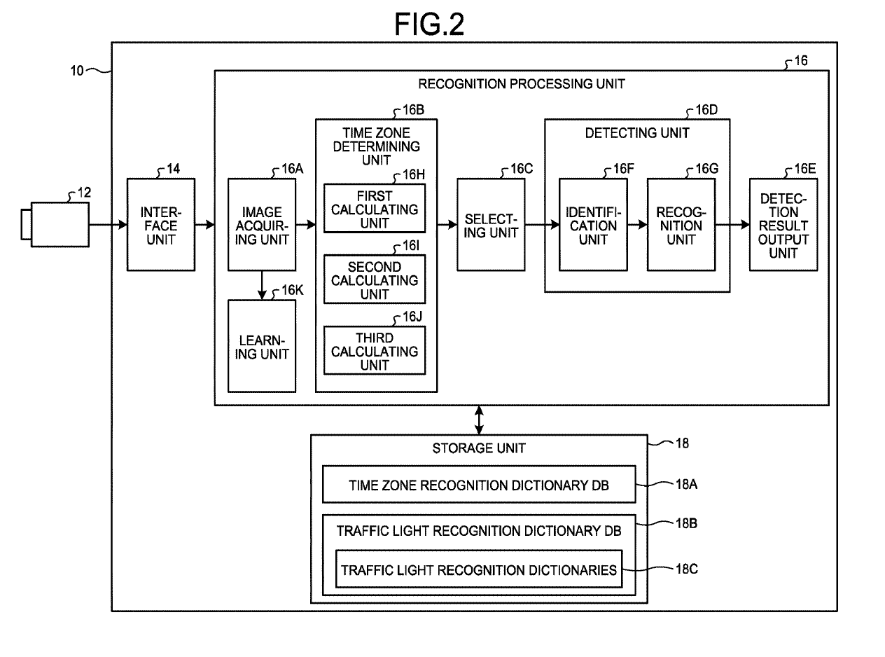

Next, a functional configuration of the information processing apparatus 10 will be described. FIG. 2 is a block diagram illustrating an example of the functional configuration of the information processing apparatus 10.

The information processing apparatus 10 includes an interface unit 14, a recognition processing unit 16, and a storage unit 18. The interface unit 14 and the storage unit 18 are electrically connected to the recognition processing unit 16.

The interface unit 14 receives the captured image from the image capturing device 12. The image capturing device 12 consecutively captures images of the surroundings of the vehicle 20 over time, and sequentially outputs the respective captured images acquired by the image capturing, in order of the image capturing, to the interface unit 14. The interface unit 14 sequentially receives the captured images from the image capturing device 12 and sequentially outputs the captured images to the recognition processing unit 16 in order of the reception.

The storage unit 18 stores therein various data. In this embodiment, the storage unit 18 stores therein a time zone recognition dictionary 18A and a traffic light recognition dictionary DB 18B. The traffic light recognition dictionary DB 18B includes therein image capturing time zones and traffic light recognition dictionaries 18C, which have been associated with each other. Details of the time zone recognition dictionary 18A, the traffic light recognition dictionary DB 18B, and the traffic light recognition dictionaries 18C will be described later.

The recognition processing unit 16 analyzes a captured image, and detects a traffic light color and a traffic light region in the captured image. The recognition processing unit 16 includes an image acquiring unit 16A, a time zone determining unit 16B, a selecting unit 16C, a detecting unit 16D, a detection result output unit 16E, and a learning unit 16K. The detecting unit 16D includes an identification unit 16F and a recognition unit 16G. The time zone determining unit 16B includes a first calculating unit 16H, a second calculating unit 16I, and a third calculating unit 16J.

A part or all of the image acquiring unit 16A, the time zone determining unit 16B, the selecting unit 16C, the detecting unit 16D, the detection result output unit 16E, the identification unit 16F, the recognition unit 16G, the first calculating unit 16H, the second calculating unit 16I, the third calculating unit 16J, and the learning unit 16K may be: realized by, for example, causing a processing device, such as a central processing unit (CPU), to execute a program, that is, by software; realized by hardware, such as an integrated circuit (IC); or realized by software and hardware in combination.

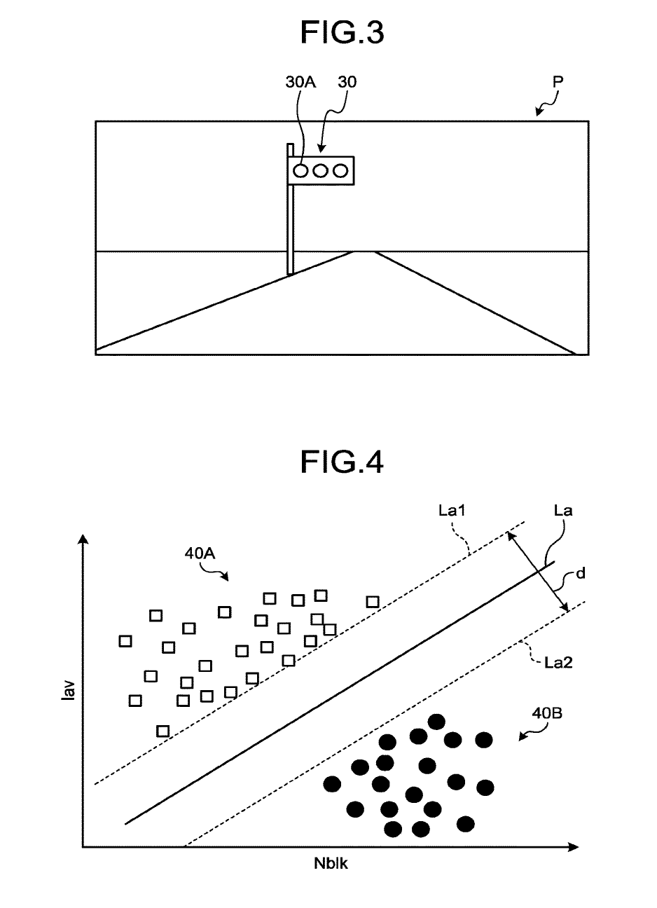

The image acquiring unit 16A acquires a captured image from the image capturing device 12. FIG. 3 is a schematic view illustrating an example of a captured image P. In this embodiment, a case where the image acquiring unit 16A acquires the captured image P including the traffic light 30 will be described.

Referring back to FIG. 2, explanation will be continued. The image acquiring unit 16A acquires the captured image P captured by the image capturing device 12. In this embodiment, the image acquiring unit 16A acquires the captured image P from the image capturing device 12 via the interface unit 14. The image acquiring unit 16A may acquire the captured image P from the storage unit 18, an external device, or the like.

In this embodiment, the image acquiring unit 16A sequentially acquires the captured image P corresponding to one frame (one sheet). The recognition processing unit 16 detects a traffic light region and a traffic light color, for each frame. The captured image P processed by the recognition processing unit 16 is, specifically, captured image data of a captured image. In order to simplify the explanation, the captured image data is referred to as the captured image P.

The time zone determining unit 16B determines an image capturing time zone of the captured image P acquired by the image acquiring unit 16A. The time zone determining unit 16B analyzes the captured image P to determine the image capturing time zone of the captured image P.

Image capturing time zones are plural time zones, into which one day (24 hours) is divided, the image capturing time zones having image capturing environments different from one another. Having different image capturing environments means having different light intensities. For example, the image capturing time zones are the daytime and the nighttime. The image capturing time zones may be the daytime, the nighttime, and the evening. Further, the image capturing time zones just need to be respective time zones resulting from division of one day into plural time zones having different image capturing environments, and are not limited to the daytime, the nighttime, the evening, and the like. Furthermore, the image capturing time zones are not limited to the two types or the three types, and there may be four or more types of the image capturing time zones. Further, the image capturing time zones may be set, as appropriate, according to the image capturing environments of captured images P (for example, seasons, countries, regions, or whether or not being in northern hemisphere or southern hemisphere).

In this embodiment, a case where the image capturing time zone represents the daytime or the nighttime will be described as an example. The image capturing time zone representing the daytime means being in a time zone in which light intensity in that image capturing environment is equal to or greater than a threshold. The image capturing time zone representing the nighttime means being in a time zone in which light intensity in that image capturing environment is less than the threshold. An arbitrary value may be defined beforehand as this threshold of light intensity. For example, as the threshold of light intensity, a light intensity, at which light quantity in a region representing the light 30A of the traffic light 30 included in the captured image P starts to be saturated by the automatic gain control function of the image capturing device 12 that has captured the captured image P to be processed (or at which the light quantity is desaturated), may be defined.

By using brightness of the captured image P, the time zone determining unit 16B determines the image capturing time zone of the captured image P.

In detail, the time zone determining unit 16B includes the first calculating unit 16H, the second calculating unit 16I, and the third calculating unit 16J.

The first calculating unit 16H calculates an average brightness of the captured image P. The first calculating unit 16H calculates an average value of respective brightness values of pixels included in the captured image P. Thereby, the first calculating unit 16H calculates the average brightness of the captured image P. When the image capturing time zone is the daytime, the average brightness of the captured image P is high. On the contrary, when the image capturing time zone is the nighttime, the average brightness of the captured image P is lower than of the daytime.

The second calculating unit 16I divides the captured image P into plural blocks. For example, the second calculating unit 16I divides the captured image P into “m×n” blocks. Herein, “m” and “n” are integers that are equal to or greater than “1”, and at least one of “m” and “n” is an integer that is equal to or greater than “2”.

The second calculating unit 16I calculates an average brightness of each of these blocks. For example, the second calculating unit 16I calculates, for each of the blocks, an average value of brightness values of pixels included in that block. Thereby, the second calculating unit 16I calculates the average brightness for each of the blocks included in the captured image P.

Further, the second calculating unit 16I calculates the small brightness block number each having an average brightness equal to or less than a threshold in the captured image P, as a small brightness block number. An arbitrary value may be defined beforehand as the threshold of average brightness used in the calculation of the small brightness block number.

The time zone determining unit 16B determines the image capturing time zone, based on feature amounts including the average brightness of the captured image P and the small brightness block number in the captured image P.

Specifically, the time zone determining unit 16B uses, as the feature amounts for the time zone determination, for example, the average brightness of the captured image P and the small brightness block number in the captured image P.

In this embodiment, the time zone determining unit 16B generates, beforehand, the time zone recognition dictionary 18A (see FIG. 2) to be used in the determination of the image capturing time zone. That is, the time zone determining unit 16B generates, beforehand, the time zone recognition dictionary 18A before the time zone determination process for the captured image P.

In this embodiment, the time zone determining unit 16B generates, beforehand, the time zone recognition dictionary 18A, using a machine learning method, in which a support vector machine (SVM) is used.

In detail, the time zone determining unit 16B uses reference captured images, which are plural captured images P captured beforehand for each image capturing time zone.

The reference captured images are captured images that are captured beforehand by the image capturing device 12 before a detection process, separately from the captured image P used by the detecting unit 16D in the detection process. The reference captured images are captured images captured by the same image capturing device 12 as the captured image P used by the detecting unit 16D in the detection process.

Firstly, the time zone determining unit 16B registers a group of sample points each represented by the average brightness and the small brightness block number in the reference captured images, in a two-dimensional space defined by average brightness and small brightness block number. FIG. 4 is a graph illustrating an example of the sample points each represented by the average brightness (Iav) and the small brightness block number (Nblk) in the reference captured images.

In FIG. 4, a sample point group 40B is a group of sample points each represented by the average brightness and the small brightness block number in the reference captured images captured in the image capturing time zone representing the nighttime. Further, a sample point group 40A is a group of sample points each represented by the average brightness and the small brightness block number in the reference captured images captured in the image capturing time zone representing the daytime.

The time zone determining unit 16B allocates a separation plane separating between the sample point group 40A of the daytime and the sample point group 40B of the nighttime (herein, a straight line La), such that a distance, “d” (which may be referred to as a margin), between respective boundary lines (a straight line La1 and a straight line La2) of the sample point group 40A of the daytime and the sample point group 40B of the nighttime is maximized. The time zone determining unit 16B then calculates an evaluation function representing this separation plane (the straight line La in FIG. 4), as the time zone recognition dictionary 18A. The following Equation (1) is an equation expressing this evaluation function representing the straight line La.

f(I,Nblk)=A×Iav+B×Nblk+C (1)

In Equation (1), f(Iav, Nblk) is the evaluation function (time zone recognition dictionary 18A) in the case where the average brightness of the captured image P and the small brightness block number in the captured image P are used as the feature amounts for the time zone determination. In Equation (1), “A”, “B”, and “C” are coefficients of the evaluation function.

The time zone determining unit 16B generates the evaluation function expressed by Equation (1) beforehand, and stores the evaluation function as the time zone recognition dictionary 18A in the storage unit 18 beforehand.

Upon determination of the image capturing time zone for the captured image P, the time zone determining unit 16B determines the image capturing time zone of the captured image P using the time zone recognition dictionary 18A (the evaluation function expressed by Equation (1)) that has been stored in the storage unit 18.

In detail, the time zone determining unit 16B applies the average brightness (Iav) and the small brightness block number (Nblk) in the captured image P that have been calculated by the first calculating unit 16H and the second calculating unit 16I to Equation (1) to calculate “f(Iav, Nblk)”.

If a value of the calculated f(Iav, Nblk) is equal to or greater than a threshold that has been defined beforehand, the time zone determining unit 16B determines that the image capturing time zone of the captured image P represents the daytime. On the contrary, if the value of the calculated f(Iav, Nblk) is less than the threshold, the time zone determining unit 16B determines that the image capturing time zone of the captured image P represents the nighttime. This threshold may be defined beforehand according to the light intensities of the image capturing environments of the image capturing time zones to be determined.

The time zone determining unit 16B may determine the image capturing time zone, based on feature amounts including the average brightness of the captured image P, the small brightness block number in the captured image P, and a variance of average brightnesses of the respective blocks in the captured image P.

In this case, the third calculating unit 16J of the time zone determining unit 16B calculates the variance of the average brightnesses of the respective blocks in the captured image P. The third calculating unit 16J calculates the variance of the average brightnesses of the respective blocks divided by the second calculating unit 16I. For example, the time zone determining unit 16B calculates a variance (σ) using the following Equation (2).

σ=\sqrt{Σᵢ₌₀^{N}(Iᵢ−Iₐᵥ)²} (2)

In Equation (2), “σ” represents the variance of the average brightnesses of the respective blocks in the captured image P. In Equation (2), “N” represents the number of blocks included in the captured image P (that is, the value of “m×n”). Further, “Ii” represents the average brightness of the i-th block. Furthermore, “Iav” represents the average brightness of the whole captured image P.

In this case, the time zone determining unit 16B may generate, beforehand, the time zone recognition dictionary 18A, in which the average brightness of the captured image P, the small brightness block number in the captured image P, and the variance of the average brightnesses of the respective blocks in the captured image P are used as the feature amounts.

That is, similarly to the case where the average brightness of the captured image P and the small brightness block number in the captured image P are used as the feature amounts, the time zone determining unit 16B may generate, beforehand, the time zone recognition dictionary 18A, using a machine learning method in which a support vector machine (SVM) is used. In this case, the time zone determining unit 16B may register a group of sample points each represented by the average brightness, the small brightness block number, and the variance, from the reference captured images, in a three-dimensional space defined by average brightness, small brightness block number, and variance.

Similarly to what has been described above, the time zone determining unit 16B allocates a separation plane separating between the sample point group of the daytime and the sample point group of the nighttime, such that the margin is maximized. The time zone determining unit 16B may then calculate, as the time zone recognition dictionary 18A, an evaluation function representing this separation plane. The following Equation (3) is the evaluation function (time zone recognition dictionary 18A) in the case where the average brightness of the captured image P, the small brightness block number in the captured image P, and the variance are used as the feature amounts for the time zone determination.

f(Iav,Nblk,σ)=A×Iav+B×Nblk+C×σ+D (3)

In Equation (3), f(Iav, Nblk, σ) is the evaluation function (time zone recognition dictionary 18A) in the case where the average brightness of the captured image P, the small brightness block number in the captured image P, and the variance are used as the feature amounts for the time zone determination. In Equation (3), “A”, “B”, “C”, and “D” are coefficients of the evaluation function.

As described above, the time zone determining unit 16B may, for example, generate the evaluation function expressed by Equation (3) beforehand, and store the evaluation function as the time zone recognition dictionary 18A in the storage unit 18 beforehand.

In this case, upon determination of the image capturing time zone of the captured image P, the time zone determining unit 16B determines the image capturing time zone of the captured image P using the time zone recognition dictionary 18A (the evaluation function expressed by Equation (3)) that has been stored in the storage unit 18.

In detail, the time zone determining unit 16B obtains the average brightness (Iav), the small brightness block number (Nblk), and the variance (σ), of the captured image P, which have been calculated respectively by the first calculating unit 16H, the second calculating unit 16I, and the third calculating unit 16J. The time zone determining unit 16B applies these average brightness (Iav), small brightness block number (Nblk), and variance (σ) to Equation (3) to calculate f(Iav, Nblk, σ).

If a value of the calculated f(Iav, Nblk, σ) is equal to or greater than a threshold that has been defined beforehand, the time zone determining unit 16B determines that the image capturing time zone of the captured image P represents the daytime. On the contrary, if the value of the calculated f(Iav, Nblk, σ) is less than the threshold, the time zone determining unit 16B determines that the image capturing time zone of the captured image P represents the nighttime. This threshold may be defined beforehand.

The time zone determining unit 16B outputs the captured image P and the determined image capturing time zone of the captured image P to the selecting unit 16C.

Referring back to FIG. 2, the selecting unit 16C selects the traffic light recognition dictionary 18C corresponding to the image capturing time zone determined by the time zone determining unit 16B.

The traffic light recognition dictionary 18C is dictionary data used by the detecting unit 16D in detecting a traffic light region of the traffic light 30 and a traffic light color indicated by the traffic light 30, according to the image capturing time zone. The traffic light recognition dictionaries 18C are stored in the storage unit 18 beforehand correspondingly to the image capturing time zones.

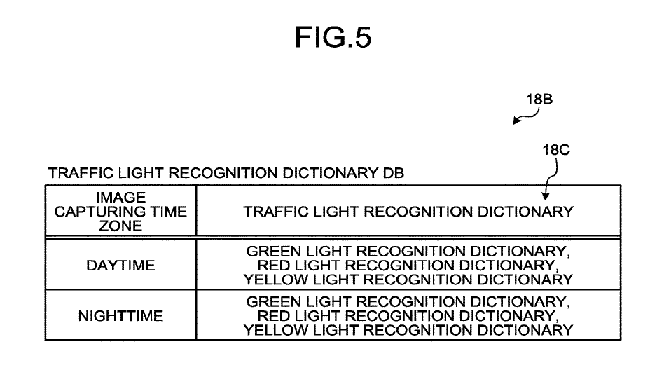

In this embodiment, the storage unit 18 stores therein the traffic light recognition dictionary DB 18B beforehand. FIG. 5 is a schematic diagram illustrating an example of a data configuration of the traffic light recognition dictionary DB 18B. The traffic light recognition dictionary DB 18B associates the image capturing time zones and the traffic light recognition dictionaries 18C corresponding to the image capturing time zones with each other.

The traffic light recognition dictionary 18C indicates ranges of color values corresponding respectively to plural types of reference traffic light colors indicated by the traffic light 30 included in the reference captured images captured in the corresponding image capturing time zone.

In this embodiment, a case where (U, V) values of a (Y, U, V) color space are used as the color values will be described. Further, in this embodiment, a case where a distribution range of (U, V) values is used as a range of color values will be described.

The reference traffic light colors are types of colors that have been defined beforehand as traffic light colors (that is, lit colors) indicated by the traffic light 30. The reference traffic light colors differ according to traffic regulations of countries or regions. In this embodiment, a case where the reference traffic light colors are of three types, which are a red color, a green color, and a yellow color, will be described as an example.

Similarly, a case where later described traffic light colors detected by the detecting unit 16D are of the three types, which are the red color, the green color, and the yellow color, will be described. Hereinafter, when a traffic light color indicated by the traffic light 30 is the red color, the indication may be referred to as a red light, when the traffic light color indicated by the traffic light 30 is the green color, the indication may be referred to as a green light, and when the traffic light color indicated by the traffic light 30 is the yellow color, the indication may be referred to as a yellow light.

In this embodiment, the traffic light recognition dictionary 18C includes traffic light color recognition dictionaries corresponding respectively to the plural types of reference traffic light colors. The traffic light color recognition dictionaries indicate ranges of color values of traffic light colors of a traffic light indicating corresponding reference traffic light colors in the reference captured images captured in the corresponding image capturing time zone.

Specifically, in this embodiment, the traffic light recognition dictionary 18C includes, as the traffic light color recognition dictionaries, a green light recognition dictionary, a red light recognition dictionary, and a yellow light recognition dictionary. The green light recognition dictionary is a traffic light recognition dictionary corresponding to the reference traffic light color, “green color”. The red light recognition dictionary is a traffic light recognition dictionary corresponding to the reference traffic light color, “red color”. The yellow light recognition dictionary is a traffic light recognition dictionary corresponding to the reference traffic light color, “yellow color”.

The captured image P acquired by the image acquiring unit 16A is an image captured by the image capturing device 12 having the automatic gain function, as described above. Therefore, depending on the image capturing time zone, the captured image P, in which the light quantity of the region (the lit region) indicating the light 30A in the traffic light 30 is saturated, may be acquired.

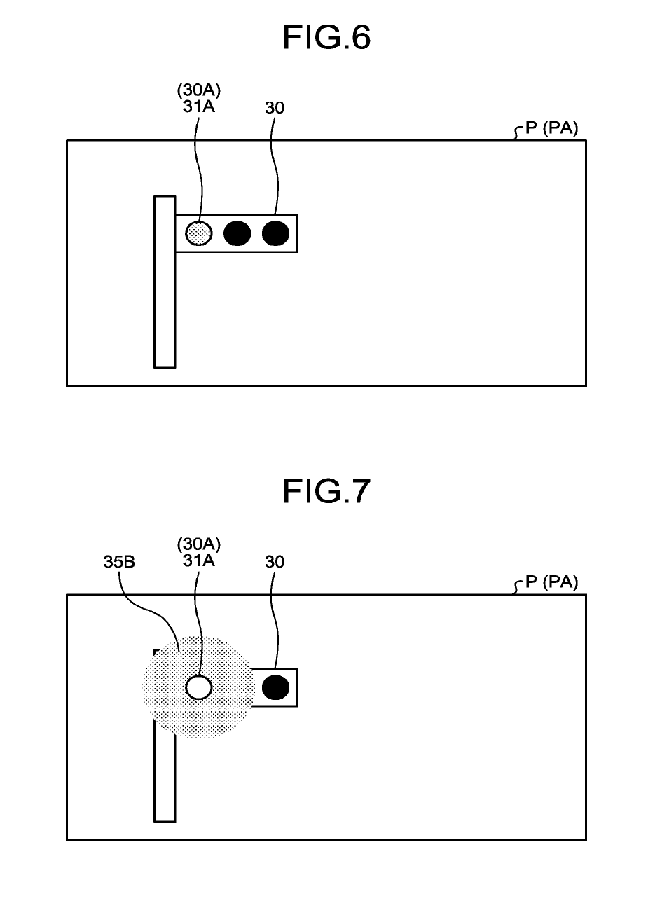

FIG. 6 and FIG. 7 are views illustrating examples of the captured image P in different image capturing time zones. FIG. 6 and FIG. 7 are each the captured image P, in which the traffic light 30 indicating the green light has been captured. Further, FIG. 6 is a schematic diagram illustrating an example of the captured image P captured in the image capturing time zone representing the daytime. FIG. 7 is a schematic diagram illustrating an example of the captured image P captured in the image capturing time zone representing the nighttime.

As illustrated in FIG. 6, when the image capturing time zone represents the daytime with a large light intensity in the image capturing environment, color values of a region 31A representing the light 30A in the captured image P indicate the green color corresponding to a traffic light color of the light 30A.

On the contrary, as illustrated in FIG. 7, when the image capturing time zone represents the nighttime with a small light intensity in the image capturing environment, color values of the region 31A representing the light 30A in the captured image P indicate a white color due to saturation of the light quantity. Further, when the image capturing time zone is the nighttime with the small light intensity in the image capturing environment, color values of a peripheral region 35B around the region 31A representing the light in the captured image P indicate the green color corresponding to the traffic light color of the light 30A.

That is, when the image capturing time zone represents the nighttime, the color values of the peripheral region 35B around the region 31A representing the light 30A indicate the color corresponding the traffic light color of the light 30A, instead of the color values of the region 31A representing the light 30A.

Therefore, in this embodiment, the traffic light recognition dictionary 18C corresponding to the image capturing time zone representing the nighttime (the green light recognition dictionary, the red light recognition dictionary, and the yellow light recognition dictionary) indicate ranges of color values in the peripheral region 35B of the region 31A representing the light 30A of the traffic light 30, in reference captured images PA that have been captured in the image capturing time zone representing the nighttime (see FIG. 7).

On the contrary, the traffic light recognition dictionary 18C corresponding to the image capturing time zone representing the daytime (the green light recognition dictionary, the red light recognition dictionary, and the yellow light recognition dictionary) indicate ranges of color values in the region 31A representing the light 30A of the traffic light 30, in reference captured images PA that have been captured in the image capturing time zone representing the daytime (see FIG. 6).

Referring back to FIG. 2, the traffic light recognition dictionaries 18C (the green light recognition dictionaries, the red light recognition dictionaries, and the yellow light recognition dictionaries) corresponding to these image capturing time zones are generated by the learning unit 16K beforehand. The learning unit 16K generates the traffic light recognition dictionaries 18C beforehand, before the detection process on the captured image P by the detecting unit 16D. The learning unit 16K learns the reference captured images PA to generate the traffic light recognition dictionaries 18C beforehand, and stores the traffic light recognition dictionaries 18C in the storage unit 18 beforehand.

In this embodiment, using a machine learning method in which an SVM is used, the learning unit 16K generates, beforehand, the traffic light recognition dictionaries 18C (the green light recognition dictionaries, the red light recognition dictionaries, and the yellow light recognition dictionaries) corresponding to the image capturing time zones.

In detail, the learning unit 16K uses, as the reference captured images PA, plural captured images P captured beforehand by the image capturing device 12 for each image capturing time zone. Further, the learning unit 16K uses the reference captured images PA respectively including the traffic light 30 in states of indicating the respective reference traffic light colors, for each of the image capturing time zones. Specifically, for each of the image capturing time zones and for each of the reference traffic light colors, the learning unit 16K executes machine learning using, for each of the image capturing time zones, the reference captured images PA including the traffic light 30 indicating the green light, the reference captured images PA including the traffic light 30 indicating the red light, and the reference captured images PA including the traffic light 30 indicating the yellow light.

Hereinafter, the generation of the traffic light recognition dictionaries 18C (the green light recognition dictionaries, the red light recognition dictionaries, and the yellow light recognition dictionaries) by the learning unit 16K will be described in detail.

By using the plural reference captured images PA corresponding to each of combinations of the image capturing time zones and the reference traffic light colors, the learning unit 16K registers, for each of the image capturing time zones and the reference traffic light colors, (U, V) values of the light 30A of the traffic light 30 in a two-dimensional space defined by the U values and V values.

Specifically, using the reference captured images PA captured in the image capturing time zone representing the daytime, for each of the reference traffic light colors, the learning unit 16K registers (U, V) values of the region 31A representing the light 30A of the traffic light 30 in the two-dimensional space. The learning unit 16K then generates, using results of this registration, the traffic light recognition dictionary 18C corresponding to the image capturing time zone, “daytime”. Further, using the reference captured images PA captured in the image capturing time zone representing the nighttime, for each of the reference traffic light colors, the learning unit 16K registers (U, V) values of the peripheral region 35B around the region 31A representing the light 30A of the traffic light 30 in the two-dimensional space. The learning unit 16K then generates, using results of this registration, the traffic light recognition dictionary 18C corresponding to the image capturing time zone, “nighttime”.

Firstly, the generation of the traffic light recognition dictionary 18C corresponding to the image capturing time zone representing the daytime will be described in detail.

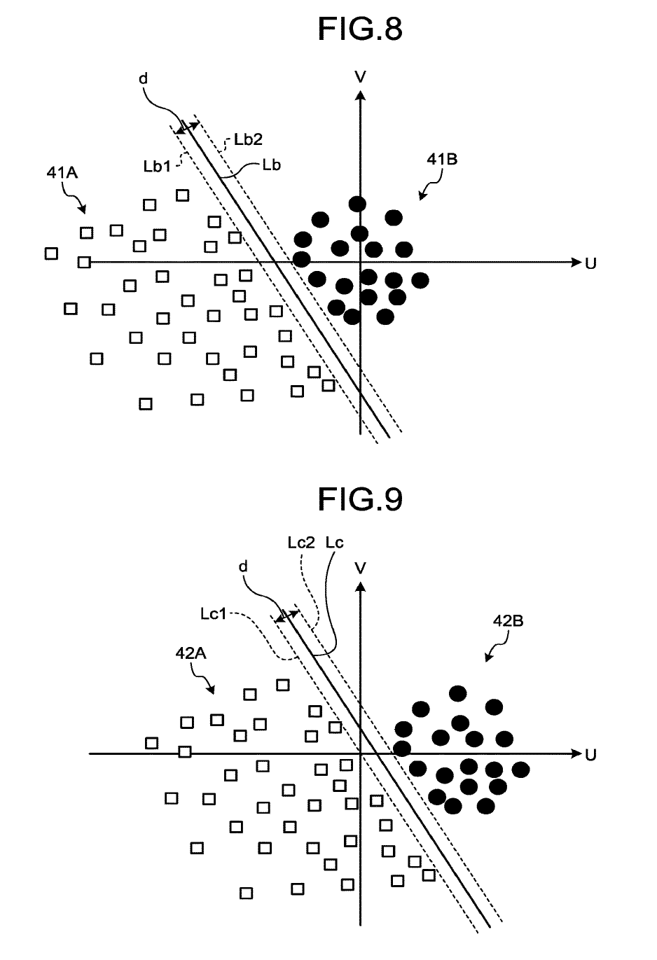

FIG. 8 is a graph illustrating an example of a distribution of (U, V) values represented by the green light recognition dictionary for the image capturing time zone representing the daytime and corresponding to the reference traffic light color, “green color”. In other words, FIG. 8 is a diagram where the (U, V) values of the region 31A (see FIG. 6) representing the light 30A of the traffic light 30 indicating the green light in the reference captured images PA captured in the image capturing time zone representing the daytime have been registered in the two-dimensional space.

In FIG. 8, a (U, V) value distribution 41B represents the distribution of the (U, V) values of the region 31A (see FIG. 6) representing the light 30A of the traffic light 30 indicating the green light, in the reference captured images PA that have been captured in the image capturing time zone representing the daytime. In this embodiment, the learning unit 16K further registers a (U, V) value distribution 41A of a region other than the region 31A from the reference captured images PA. That is, the (U, V) value distribution 41A is a distribution of color values of the region other than the region 31A representing the light 30A of the green light in the reference captured images PA.

The learning unit 16K arranges a separation plane (herein, a straight line Lb) separating between the (U, V) value distribution 41B representing the green light and the (U, V) value distribution 41A excluding the green light, such that a distance “d” between respective boundary lines (a straight line Lb1 and a straight line Lb2) of the (U, V) value distribution 41B and the (U, V) value distribution 41A is maximized. The learning unit 16K then calculates an evaluation function representing this separation plane (the straight line Lb in FIG. 8). The following Equation (4) is an equation expressing the evaluation function representing this straight line Lb.

f(U,V)=a×U+b×V+c (4)

In Equation (4), f(U, V) is an evaluation function representing the green light recognition dictionary. In Equation (4), “a”, “b”, and “c” are coefficients of the evaluation function.

As described above, the learning unit 16K calculates the green light recognition dictionary (the evaluation function expressed by Equation (4)) corresponding to the image capturing time zone representing the daytime. Further, the learning unit 16K similarly calculates the red light recognition dictionary and the yellow light recognition dictionary, using the reference captured images PA capturing therein the traffic light 30 indicating the respective traffic light colors in the daytime. The coefficients (“a”, “b”, and “c”) included in the evaluation functions corresponding to the respective green light recognition dictionary, red light recognition dictionary, and yellow light recognition dictionary, which correspond to the image capturing time zone representing the daytime, are values according to the respective dictionaries, and at least one of the coefficients is mutually different among the dictionaries.

Thereby, the learning unit 16K generates the traffic light recognition dictionary 18C (the green light recognition dictionary, the red light recognition dictionary, and the yellow light recognition dictionary) corresponding to the image capturing time zone representing the daytime. That is, the learning unit 16K generates the traffic light recognition dictionary 18C (the green light recognition dictionary, the red light recognition dictionary, and the yellow light recognition dictionary) indicating ranges of color values of the region 31A representing the light 30A of the traffic light 30 in the reference captured images PA that have been captured in the image capturing time zone representing the daytime.

Next, the generation of the traffic light recognition dictionary 18C corresponding to the image capturing time zone representing the nighttime will be described.

FIG. 9 is a graph illustrating an example of a distribution of (U, V) values represented by the green light recognition dictionary for the image capturing time zone representing the nighttime and corresponding to the reference traffic light color, “green color”. In other words, FIG. 9 is a diagram where the (U, V) values of the peripheral region 35B (see FIG. 7) around the region 31A representing the light 30A of the traffic light 30 indicating the green light in the reference captured images PA captured in the image capturing time zone representing the nighttime have been registered in a two-dimensional space.

In FIG. 9, a (U, V) value distribution 42B represents the distribution of the (U, V) values of the peripheral region 35B (see FIG. 7) around the region 31A representing the light 30A of the traffic light 30 indicating the green light, in the reference captured images PA that have been captured in the image capturing time zone representing the nighttime. In this embodiment, the learning unit 16K further registers a (U, V) value distribution 42A of a region other than the peripheral region 35B in the reference captured images PA. That is, the (U, V) value distribution 42A is a distribution of color values other than color values of the green light in the reference captured images PA.

The learning unit 16K arranges a separation plane (herein, a straight line Lc) separating between the (U, V) value distribution 42B representing the green light and the (U, V) value distribution 42A excluding the green light, such that a distance “d” between respective boundary lines (a straight line Lc1 and a straight line Lc2) of the (U, V) value distribution 42B and the (U, V) value distribution 42A is maximized. The learning unit 16K then calculates an evaluation function representing this separation plane (the straight line Lc in FIG. 9). This evaluation function is the same as the above Equation (4), and at least one of the coefficients (“a”, “b”, and “c”) is different from the above.

As described above, the learning unit 16K calculates the green light recognition dictionary (the evaluation function expressed by Equation (4)) corresponding to the image capturing time zone representing the nighttime. Further, the learning unit 16K similarly calculates the red light recognition dictionary and the yellow light recognition dictionary, using the reference captured images PA capturing therein the traffic light 30 indicating the respective traffic light colors in the nighttime. The coefficients (“a”, “b”, and “c”) included in the evaluation functions corresponding to the respective green light recognition dictionary, red light recognition dictionary, and yellow light recognition dictionary, which correspond to the image capturing time zone representing the nighttime, are values according to the respective dictionaries.

Thereby, the learning unit 16K generates the traffic light recognition dictionary 18C (the green light recognition dictionary, the red light recognition dictionary, and the yellow light recognition dictionary) corresponding to the image capturing time zone representing the nighttime. That is, the learning unit 16K generates the traffic light recognition dictionary 18C (the green light recognition dictionary, the red light recognition dictionary, and the yellow light recognition dictionary) indicating ranges of color values of the peripheral region 35B around the region 31A representing the light 30A of the traffic light 30 in the reference captured images PA that have been captured in the image capturing time zone representing the nighttime.

The learning unit 16K may store, as the traffic light recognition dictionary 18C, the ranges of color values corresponding to the reference traffic light colors (the (U, V) value distribution 41B and the (U, V) value distribution 42B) as illustrated in FIG. 8 and FIG. 9, in the storage unit 18. Further, as described above, the learning unit 16K may store, as the traffic light recognition dictionary 18C, the evaluation functions expressed by the above Equation (4) obtained from the distributions, in the storage unit 18.

In this embodiment, a case where the learning unit 16K generates, as the traffic light recognition dictionaries 18C, the evaluation functions expressed by the above Equation (4) corresponding to the image capturing time zones and the reference traffic light colors, and stores the traffic light recognition dictionaries 18C in the storage unit 18 beforehand will be described.

Referring back to FIG. 2, explanation will be continued. As described above, the selecting unit 16C selects the traffic light recognition dictionary 18C corresponding to the image capturing time zone determined by the time zone determining unit 16B. In detail, the selecting unit 16C reads the traffic light recognition dictionary 18C (the green light recognition dictionary, the red light recognition dictionary, and the yellow light recognition dictionary) corresponding to the image capturing time zone determined by the time zone determining unit 16B, from the traffic light recognition dictionary DB 18B in the storage unit 18. Thereby, the selecting unit 16C selects the traffic light recognition dictionary 18C corresponding to the determined image capturing time zone.

The detecting unit 16D detects, based on the image capturing time zone determined by the time zone determining unit 16B, a traffic light region of the traffic light 30 and a traffic light color indicated by the traffic light 30 in the captured image P.

In this embodiment, the detecting unit 16D detects the traffic light region and the traffic light color, using the traffic light recognition dictionary 18C selected by the selecting unit 16C.

The detecting unit 16D includes the identification unit 16F and the recognition unit 16G.

The identification unit 16F identifies, in the captured image P, a traffic light candidate region, which is a region belonging to a range of color values of the reference traffic light colors represented by the traffic light recognition dictionary 18C selected by the selecting unit 16C. Further, the identification unit 16F identifies the traffic light color, which is the reference traffic light color of a type corresponding to color values of the traffic light candidate region.

In detail, if the captured image P is captured image data of an (R, G, B) color space, the identification unit 16F firstly converts the captured image data into captured image data of a (Y, U, V) color space. If the captured image P is captured image data of a (Y, U, V) color space, this conversion does not need to be executed.

The identification unit 16F converts the captured image P of the (R, G, B) color space into the captured image P of the (Y, U, V) color space, using, for example, the following Equation (5).

$$[ \begin{matrix}Y \\ U \\ V\end{matrix} ] = [ \begin{matrix}0.299 & 0.587 & 0.114 \\ - 0.147 & - 0.289 & 0.436 \\ 0.615 & - 0.515 & 0.100\end{matrix} ] [ \begin{matrix}R \\ G \\ B\end{matrix} ] \qquad ( 5 )$$

The identification unit 16F then identifies, per pixel constituting the captured image P of the (Y, U, V) color space, a traffic light candidate region, which is a region, where (U, V) values of its pixels belong to a range of color values of the reference traffic light colors represented by the traffic light recognition dictionary 18C corresponding to the image capturing time zone. Further, the identification unit 16F identifies the traffic light color, which is the reference traffic light color of a type corresponding to color values of the traffic light candidate region.

In detail, firstly, the identification unit 16F reads the evaluation functions (see the above Equation (4)) corresponding to the traffic light recognition dictionary 18C (the green light recognition dictionary, the red light recognition dictionary, and the yellow light recognition dictionary) selected by the selecting unit 16C. That is, the identification unit 16F reads the evaluation functions respectively representing the traffic light recognition dictionary 18C (the green light recognition dictionary, the red light recognition dictionary, and the yellow light recognition dictionary) for the respective reference traffic light colors corresponding to the image capturing time zone.

The identification unit 16F then substitutes, for each of pixels constituting the captured image P in the (Y, U, V) color space, (U, V) values of the pixel, in the equations (Equation (4)) representing these evaluation functions. The identification unit 16F then determines any pixel with a calculated value expressed by the evaluation function being equal to or greater than a predetermined threshold, as a pixel constituting a traffic light candidate region. This threshold may be defined beforehand. By this determination, the identification unit 16F identifies, in the captured image P, the traffic light candidate region, which is the region belonging to the range of color values of the reference traffic light colors represented by the traffic light recognition dictionary 18C corresponding to the image capturing time zone.

Further, the identification unit 16F identifies the traffic light color, which is the reference traffic light color of a type corresponding to color values of the traffic light candidate region. In detail, the reference traffic light color, which corresponds to the evaluation function (any of the green light recognition dictionary, the red light recognition dictionary, and the yellow light recognition dictionary) used when the (U, V) values of the pixels of the traffic light candidate region have been determined to be equal to or greater than the threshold, is identified as the traffic light color of the traffic light candidate region. This threshold may be defined beforehand.

The recognition unit 16G recognizes, based on the traffic light candidate region identified by the identification unit 16F, the traffic light region in the captured image P. Thereby, the detecting unit 16D detects the traffic light region and the traffic light color in the captured image P.

The detection process by the detecting unit 16D will now be described specifically.

Firstly, a case where the image capturing time zone of the captured image P represents the daytime will be described specifically.

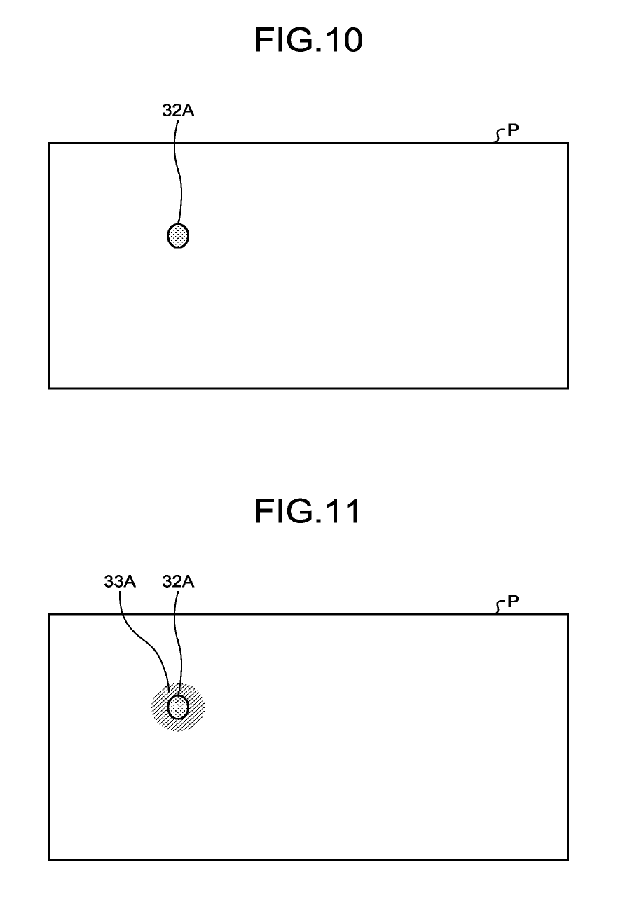

FIG. 10 to FIG. 14 are explanatory views for an example of the detection process for a traffic light region and a traffic light color, in the case where the image capturing time zone of the captured image P represents the daytime.

For example, the identification unit 16F identifies a traffic light candidate region 32A from the captured image P (see FIG. 6) captured in the image capturing time zone representing the daytime (see FIG. 10). As described above, the identification unit 16F identifies, using the traffic light recognition dictionary 18C corresponding to the image capturing time zone, “daytime”, the traffic light candidate region and the traffic light color.

Ad described above, the traffic light recognition dictionary 18C corresponding to the image capturing time zone representing the daytime indicates ranges of color values in the region 31A representing the light 30A of the traffic light 30, in the reference captured images PA that have been captured in the image capturing time zone representing the daytime.

Thus, the identification unit 16F identifies, as the traffic light candidate region 32A, for example, a region corresponding to the region 31A representing the light 30A, from the captured image P illustrated in FIG. 6 (see FIG. 10).

The recognition unit 16G recognizes, based on the identified traffic light candidate region 32A, the traffic light region.

The identification unit 16F sometimes identifies, as the traffic light candidate region 32A, a range narrower than the actual region representing the traffic light color. That is, pixels that are to be identified as a traffic light region are sometimes not extracted due to influence of noise or the like.

The recognition unit 16G thus expands the traffic light candidate region 32A. Thereby, the recognition unit 16G obtains an expanded region 33A resulting from the expansion of the traffic light candidate region 32A (see FIG. 11). Specifically, the recognition unit 16G obtains, as the expanded region 33A: the traffic light candidate region 32A; and one or more pixels continuous with an outer periphery of the traffic light candidate region 32A outward from the outer periphery.

The number of expanded pixels may be defined beforehand. For example, the recognition unit 16G adds a region continuous outward over seven pixels from the outer periphery to the outer periphery of the traffic light candidate region 32A to obtain the expanded region 33A.

Next, if a stereotype region having a predetermined shape is included in the expanded region 33A, the recognition unit 16G recognizes, as the traffic light region, a region including the stereotype region. As this predetermined shape, a shape of the light 30A of the traffic light 30 included in the captured image P may be defined beforehand. In this embodiment, a case where this shape is circular will be described as an example.

The shape of the light 30A differs according to traffic regulations established in each country, region, or the like. Thus, in the information processing apparatus 10, according to the shape of the light 30A of the traffic light 30 to be detected, the recognition unit 16G may define the shape to be used in the recognition beforehand.

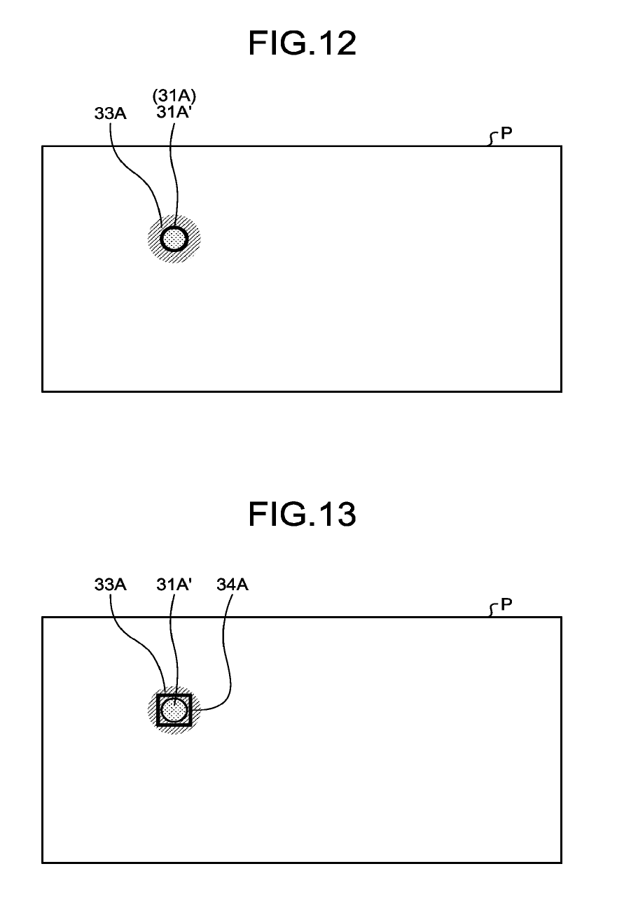

In this embodiment, the recognition unit 16G executes Hough conversion of the expanded region 33A, and determines whether or not a stereotype region 31A′ that is circular is able to extracted from the expanded region 33A (see FIG. 12). If the stereotype region 31A′ is able to be extracted, the recognition unit 16G recognizes, as a traffic light region, a region including the stereotype region 31A′.

In this embodiment, the recognition unit 16G recognizes, as a traffic light region 34A, a rectangular region circumscribing the stereotype region 31A′ in the expanded region 33A (see FIG. 13).

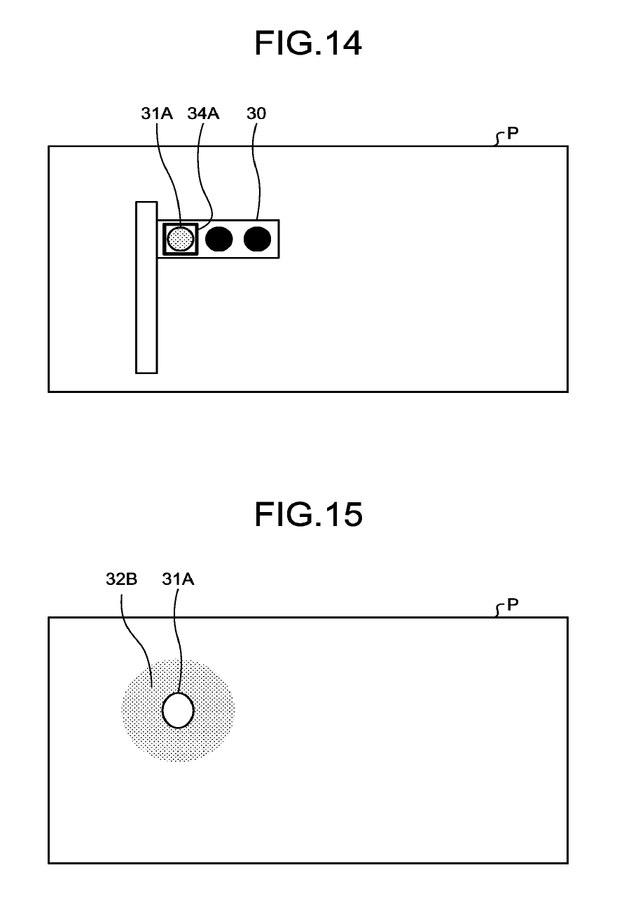

As described above, the detecting unit 16D detects, from the captured image P, the traffic light color identified by the identification unit 16F, and the traffic light region 34A recognized by the recognition unit 16G (see FIG. 14).

Next, a case where the image capturing time zone of the captured image P represents the nighttime will be described specifically.

FIG. 15 to FIG. 18 are explanatory views for an example of the detection process for a traffic light region and a traffic light color, in the case where the image capturing time zone of the captured image P represents the nighttime.

For example, the identification unit 16F identifies a traffic light candidate region 32B from the captured image P captured in the image capturing time zone representing the nighttime (see FIG. 15). As described above, the identification unit 16F identifies, using the traffic light recognition dictionary 18C corresponding to the image capturing time zone, “nighttime”, the traffic light candidate region and the traffic light color. As described above, the traffic light recognition dictionary 18C corresponding to the image capturing time zone representing the nighttime indicates ranges of color values in the peripheral region 35B around the region 31A representing the light 30A of the traffic light 30, in reference captured images PA that have been captured in the image capturing time zone representing the nighttime (see FIG. 7).

Thus, the identification unit 16F identifies, as the traffic light candidate region 32B, for example, a region corresponding to the peripheral region 35B around the region 31A representing the light 30A, from the captured image P illustrated in FIG. 7 (see FIG. 15).

The recognition unit 16G recognizes, based on the identified traffic light candidate region 32B, the traffic light region.

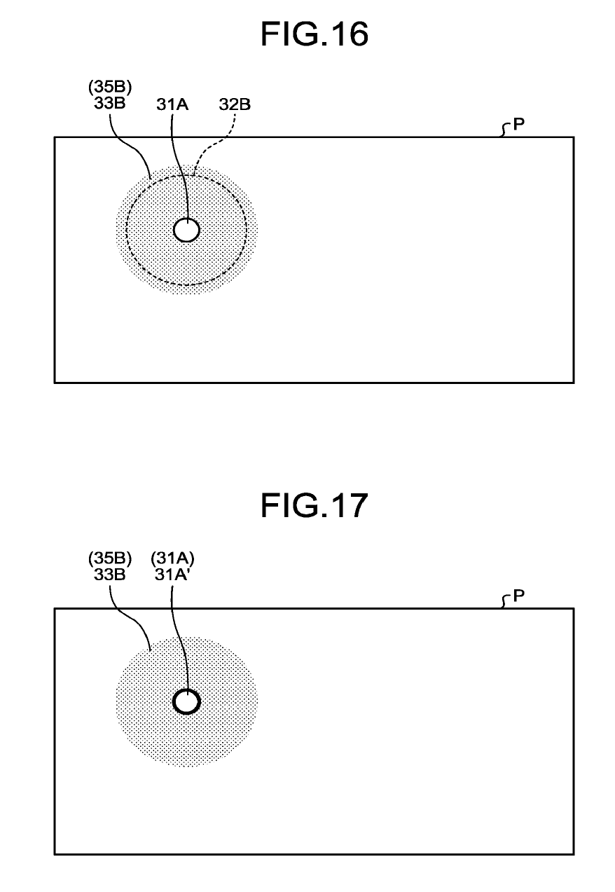

The identification unit 16F sometimes identifies, as the traffic light candidate region 32B, a range narrower than the actual region representing the traffic light color. The recognition unit 16G thus expands the traffic light candidate region 32B. Thereby, the recognition unit 16G obtains an expanded region 33B resulting from the expansion of the traffic light candidate region 32B (see FIG. 16). Specifically, the recognition unit 16G obtains, as the expanded region 33B: the traffic light candidate region 32B; and one or more pixels continuous with an outer periphery of the traffic light candidate region 32B outward from the outer periphery. That is, as compared to the traffic light candidate region 32B, this expanded region 33B becomes a region closer to the peripheral region 35B (see FIG. 16).

Next, if a stereotype region having a predetermined shape is included in the expanded region 33B, the recognition unit 16G recognizes, as the traffic light region, a region including the stereotype region. This predetermined shape is similar to the above.

In this embodiment, the recognition unit 16G executes Hough conversion of the expanded region 33B, and determines whether or not the stereotype region 31A′ that is circular is able to extracted from the expanded region 33B (see FIG. 17). If the stereotype region 31A′ is able to be extracted, the recognition unit 16G recognizes, as the traffic light region, a region including the stereotype region 31A′.

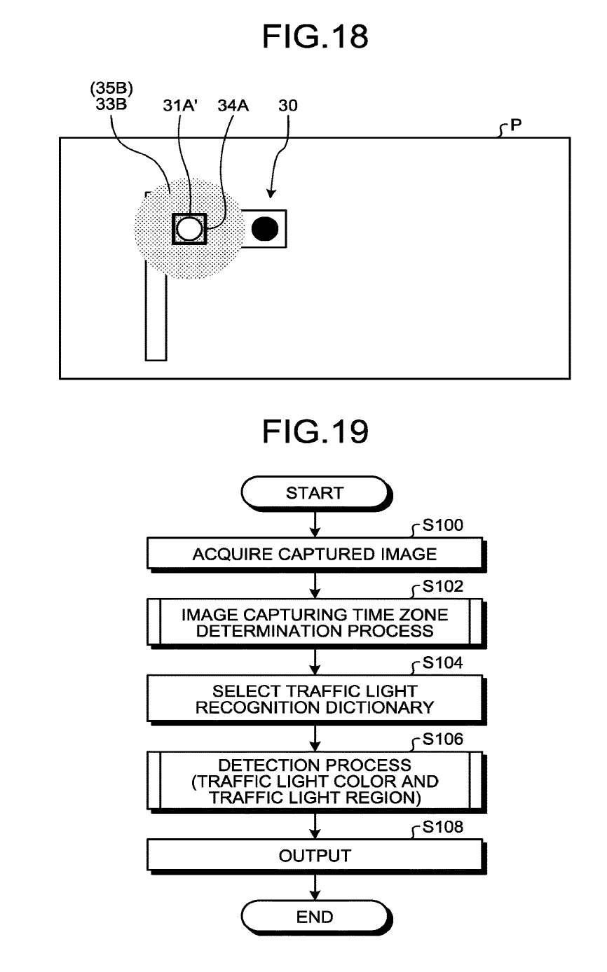

In this embodiment, the recognition unit 16G recognizes, as the traffic light region 34A, a rectangular region circumscribing the stereotype region 31A′ in the expanded region 33B (see FIG. 18). As described above, the detecting unit 16D detects the traffic light color identified by the identification unit 16F, and the traffic light region 34A recognized by the recognition unit 16G.

Referring back to FIG. 2, explanation will be continued. The detecting unit 16D outputs results of the detection including the detected traffic light color and traffic light region 34A, to the detection result output unit 16E.

The detection result output unit 16E outputs the results of the detection received from the detecting unit 16D to an external device. The external device is a known device that executes various types of processing using the results of the detection. For example, the external device assists a driver of the vehicle 20 using the results of the detection. Specifically, using the recognition result, the external device determines a driving situation of the vehicle 20, and outputs, according to a result of this determination, an alarm signal to the driver. Further, according to the result of the determination, the external device evaluates quality of driving of the driver.

The detection result output unit 16E may output the results of the detection to the external device via wireless communication or the like, using a known communication means. The detection result output unit 16E may store the results of the detection in the storage unit 18 or an external memory.

Next, an example of a procedure of information processing executed by the information processing apparatus 10 of this embodiment will be described. FIG. 19 is a flow chart illustrating an example of the procedure of the information processing executed by the information processing apparatus 10.

Firstly, the image acquiring unit 16A acquires a captured image P (Step S100). Next, the time zone determining unit 16B executes an image capturing time zone determination process of determining an image capturing time zone of the captured image P acquired in Step S100 (Step S102) (details thereof being described later).

Next, the selecting unit 16C selects the traffic light recognition dictionary 18C corresponding to the image capturing time zone determined in Step S102 (Step S104).

Next, the detecting unit 16D executes a detection process using the captured image P acquired in Step S100 and the traffic light recognition dictionary 18C selected in Step S104 (Step S106) (details thereof being described later). By the processing of Step S106, the detecting unit 16D detects a traffic light region and a traffic light color of the traffic light 30 in the captured image P acquired in Step S100.

Next, the detection result output unit 16E outputs results of the detection in Step S106 (Step S108). This routine is then ended.

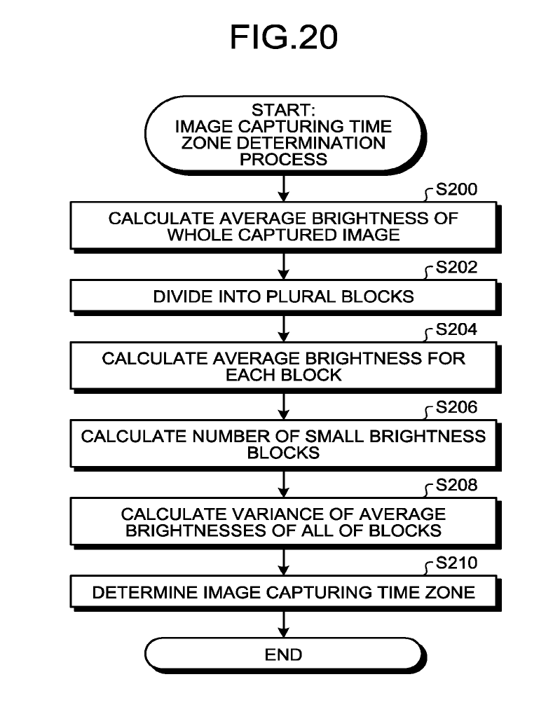

Next, a procedure of the image capturing time zone determination process (Step S102 in FIG. 19) will be described. FIG. 20 is a flow chart illustrating an example of a procedure of the image capturing time zone determination process executed by the time zone determining unit 16B.

Firstly, the first calculating unit 16H of the time zone determining unit 16B calculates an average brightness of the whole captured image P acquired in Step S100 (see FIG. 19) (Step S200).

Next, the second calculating unit 16I of the time zone determining unit 16B divides the captured image P acquired in Step S100 (see FIG. 19) into plural blocks (Step S202). Next, the second calculating unit 16I calculates an average brightness for each of the blocks (Step S204).

Next, the second calculating unit 16I calculates the small brightness block number in the captured image P, the number being the number of blocks in the captured image P acquired in Step S100 (see FIG. 19), the blocks each having an average brightness equal to or less than a threshold (Step S206).

Next, the third calculating unit 16J of the time zone determining unit 16B calculates a variance of the average brightnesses of the respective blocks in the captured image P acquired in Step S100 (see FIG. 19) (Step S208).

Next, based on the average brightness of the captured image P calculated in Step S200, the small brightness block number calculated in Step S206, and the variance of the average brightnesses calculated in Step S208; the time zone determining unit 16B determines the image capturing time zone (Step S210). This routine is then ended.

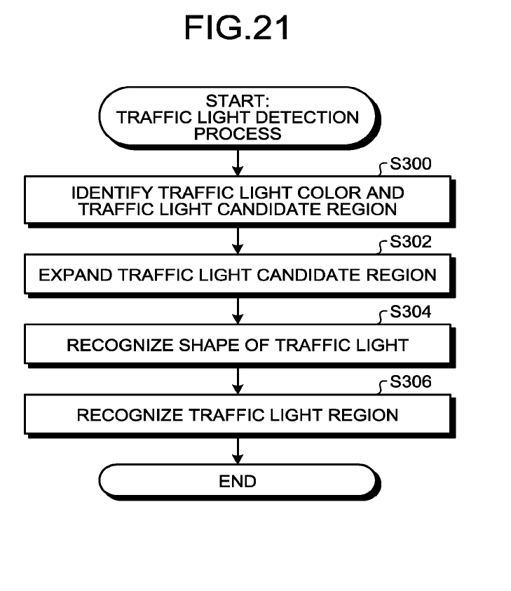

Next, a procedure of the detection process (Step S106 in FIG. 19) will be described. FIG. 21 is a flow chart illustrating an example of the procedure of the detection process executed by the detecting unit 16D.

Firstly, the identification unit 16F of the detecting unit 16D identifies a traffic light candidate region and a traffic light color in the captured image P acquired in Step S100 (see FIG. 19), using the traffic light recognition dictionary 18C selected by the selecting unit 16C in Step S104 (see FIG. 19) (Step S300).

Next, the recognition unit 16G of the detecting unit 16D expands the traffic light candidate region (Step S302). Thereby, the recognition unit 16G obtains an expanded region resulting from the expansion of the traffic light candidate region.

Next, the recognition unit 16G executes Hough conversion of the expanded region, and determines whether or not a circular stereotype region is able to be extracted from the expanded region (Step S304). If the stereotype region is able to be extracted, the recognition unit 16G recognizes, as the traffic light region 34A, a rectangular region circumscribing the stereotype region (Step S306). This routine is then ended.

As described above, the detecting unit 16D detects the traffic light color identified in Step S300 and the traffic light region 34A recognized in Step S306.

As described above, the information processing apparatus 10 of this embodiment includes the image acquiring unit 16A, the time zone determining unit 16B, and the detecting unit 16D. The image acquiring unit 16A acquires the captured image P. The time zone determining unit 16B determines the image capturing time zone of the captured image P. Based on the determined image capturing time zone, the detecting unit 16D detects the traffic light region 34A of the traffic light 30 and the traffic light color indicated by the traffic light 30 in the captured image P.

Accordingly, the information processing apparatus 10 of this embodiment detects the traffic light color and the traffic light region 34A from the captured image P, according to the image capturing time zone of the captured image P.

Therefore, the information processing apparatus 10 of this embodiment is able to accurately detect the traffic light region 34A and the traffic light color of the traffic light 30 from the captured image P.

Further, the information processing apparatus 10 is able to accurately detect the traffic light region 34A and the traffic light color of the traffic light 30 from the captured image P, regardless of the image capturing time zone. Furthermore, the information processing apparatus 10 is able to shorten the detection time because the traffic light region 34A and the traffic light color are detected from the captured image P by use of the single captured image P.

Further, the time zone determining unit 16B includes the first calculating unit 16H and the second calculating unit 16I. The first calculating unit 16H calculates the average brightness of the captured image P. The second calculating unit 16I divides the captured image P into plural blocks, and calculates the small brightness block number, which is the number of blocks each having an average brightness equal to or less than a threshold. The time zone determining unit 16B then determines the image capturing time zone, based on feature amounts including the average brightness of the captured image P, and the small brightness block number.

Further, the time zone determining unit 16B includes the first calculating unit 16H, the second calculating unit 16I, and the third calculating unit 16J. The first calculating unit 16H calculates the average brightness of the captured image P. The second calculating unit 16I divides the captured image P into plural blocks, and calculates the small brightness block number, which is the number of blocks, each having an average brightness equal to or less than a threshold. The third calculating unit 16J calculates a variance of the average brightnesses of the respective blocks in the captured image P. The time zone determining unit 16B then determines the image capturing time zone, based on feature amounts including the average brightness of, the small brightness block number in, and the variance in the captured image P.

Further, the time zone determining unit 16B determines that the image capturing time zone of the captured image P represents the daytime or the nighttime. Thus, the information processing apparatus 10 of this embodiment is able to accurately detect the traffic light region 34A and the traffic light color of the traffic light 30 from the captured image P captured in each of the image capturing time zones, even if the image capturing time zone of the captured image P changes from the daytime to the nighttime, or from the nighttime to the daytime.

The selecting unit 16C selects the traffic light recognition dictionary 18C corresponding to the determined image capturing time zone. Using the selected traffic light recognition dictionary 18C, the detecting unit 16D detects a traffic light region 34A and the traffic light color.

The traffic light recognition dictionary 18C indicates ranges of color values corresponding respectively to reference traffic light colors of plural types indicated by the traffic light 30 included in reference captured images captured in the corresponding image capturing time zone. The detecting unit 16D includes the identification unit 16F, and the recognition unit 16G. The identification unit 16F identifies, in the captured image P, a traffic light candidate region (the traffic light candidate region 32A or the traffic light candidate region 32B), which is a region belonging to a range of color values of reference traffic light colors represented by the selected traffic light recognition dictionary 18C. Further, the identification unit 16F identifies a traffic light color, which is the reference traffic light color of a type corresponding to color values of the traffic light candidate region (traffic light candidate region 32A or traffic light candidate region 32B). Based on the traffic light candidate region (traffic light candidate region 32A or traffic light candidate region 32B), the recognition unit 16G recognizes the traffic light region 34A. The detecting unit 16D detects the identified traffic light color and the recognized the traffic light region 34A.

The traffic light recognition dictionary 18C corresponding to the image capturing time zone representing the nighttime indicates ranges of color values of a peripheral region around a region representing a light of the traffic light 30 in the reference captured images captured in the image capturing time zone representing the nighttime.

The traffic light recognition dictionary 18C corresponding to the image capturing time zone representing the daytime indicates ranges of color values of a region representing a light of the traffic light 30 in the reference captured images captured in the image capturing time zone representing the daytime.

If a stereotype region having a predetermined shape is included in an expanded region expanded from the identified traffic light candidate region (the traffic light candidate region 32A or the traffic light candidate region 32B), the recognition unit 16G recognizes the region including the stereotype region as the traffic light region 34A.

If a circular stereotype region is included in the expanded region (expanded region 33a or expanded region 33b), the recognition unit 16G recognizes the region including the stereotype region as the traffic light region 34A.

### Second Embodiment

In this embodiment, a subject other than the traffic light 30 included in a captured image P being misrecognized as a traffic light region (the traffic light region 34A) is prevented.

FIG. 1 is an explanatory diagram for an example of an information processing apparatus 11A of this embodiment. In this embodiment, similarly to the information processing apparatus 10 of the first embodiment, a mode where the information processing apparatus 11A has been installed in the vehicle 20 will be described as an example.

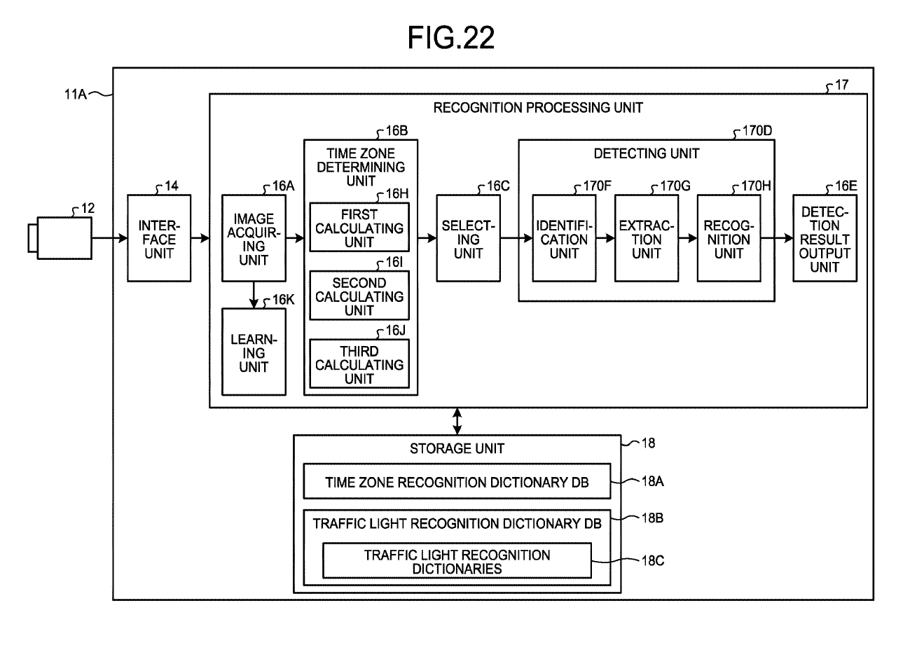

Next, a functional configuration of the information processing apparatus 11A will be described. FIG. 22 is a block diagram of an example of the functional configuration of the information processing apparatus 11A. The information processing apparatus 11A includes the interface unit 14, a recognition processing unit 17, and the storage unit 18. The interface unit 14 and the storage unit 18 are electrically connected to the recognition processing unit 17.

The interface unit 14 and the storage unit 18 are the same as the first embodiment. That is, the information processing apparatus 11A is the same as the information processing apparatus 10 of the first embodiment, except for the inclusion of the recognition processing unit 17 instead of the recognition processing unit 16.

The recognition processing unit 17 includes the image acquiring unit 16A, the time zone determining unit 16B, the selecting unit 16C, a detecting unit 170D, the detection result output unit 16E, and the learning unit 16K. The recognition processing unit 17 is the same as the recognition processing unit 16 of the first embodiment, except for the inclusion of the detecting unit 170D instead of the detecting unit 16D.

Similarly to the detecting unit 16D of the first embodiment, the detecting unit 170D detects, based on the image capturing time zone determines by the time zone determining unit 16B, a traffic light region of the traffic light 30 and a traffic light color indicated by the traffic light 30, in a captured image P. That is, using the traffic light recognition dictionary 18C selected by the selecting unit 16C, the detecting unit 170D detects the traffic light region and the traffic light color.

The detecting unit 170D includes an identification unit 170F, an extraction unit 170G, and a recognition unit 170H.

Similarly to the identification unit 16F of the first embodiment, the identification unit 170F identifies a traffic light candidate region, which is a region belonging to a range of color values of reference traffic light colors represented by the traffic light recognition dictionary 18C selected by the selecting unit 16C, in the captured image P. Further, similarly to the identification unit 16F of the first embodiment, the identification unit 170F identifies a traffic light color, which is the reference traffic light color of a type corresponding to color values of the traffic light candidate region.

A captured image P sometimes includes a subject indicating a color similar to a traffic light color of the traffic light 30. In this case, the identification unit 170F may identify the subject other than the traffic light 30 as a traffic light candidate region.

Thus, in this embodiment, the detecting unit 170D removes the subject other than the traffic light 30 in the identified traffic light candidate region, extracts a traffic light candidate region representing the traffic light 30, and uses the extracted traffic light candidate region in detection.

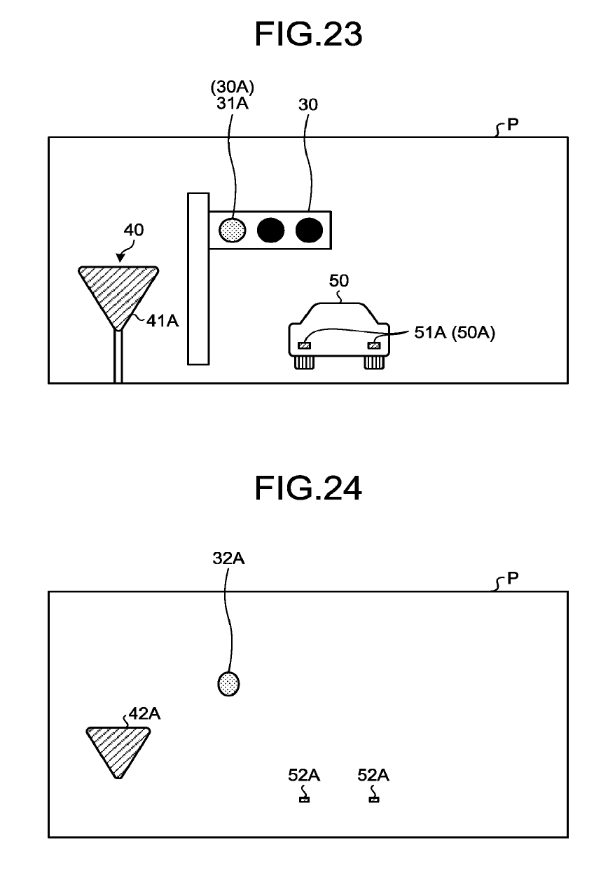

FIG. 23 to FIG. 25 are explanatory views for an example of a detection process executed by the detecting unit 170D.

FIG. 23 is a schematic diagram illustrating an example of a captured image P including plural types of subjects. As illustrated in FIG. 23, the traffic light 30, and subjects (for example, a traffic sign 40, and lamps 50A of a vehicle 50) indicating colors similar to a traffic light color of the traffic light 30 may be included in the captured image P.

For example, it will be assumed that color values of the region 31A representing the light 30A in the captured image P represent a red color. It will also be assumed that each of color values of a region 41A representing a sign of the traffic sign 40 and color values of lit regions 51A representing the lamps 50A of the vehicle 50, the region 41A and the lit region 51A being included in the captured image P, also represent a red color.

In this case, using the traffic light recognition dictionary 18C corresponding to the image capturing time zone, the identification unit 170F identifies the traffic light candidate region 32A, which is a region corresponding to the region 31A representing the light 30A, from the captured image P illustrated in FIG. 23 (see FIG. 24). Further, similarly, using the traffic light recognition dictionary 18C corresponding to the image capturing time zone, the identification unit 170F identifies a traffic light candidate region 42A and traffic light candidate regions 52A, which are respectively a region corresponding to the region 41A representing the sign and regions corresponding to the lit regions 51A, from the captured image P illustrated in FIG. 23 (see FIG. 24).

As described above, when subjects other than the traffic light 30, the subjects indicating colors similar to the traffic light color, are included in the captured image P, the identification unit 170F sometimes identifies the subjects other than the traffic light 30 as traffic light candidate regions (the traffic light candidate region 42A and the traffic light candidate regions 52A).

The extraction unit 170G extracts, from the traffic light candidate regions (the traffic light candidate region 32A, the traffic light candidate region 42A, and the traffic light candidate regions 52A) identified by the identification unit 170F, a detection target, which is a traffic light candidate region having a size in a predetermined range when expanded into an expanded region expanded from the traffic light candidate region.

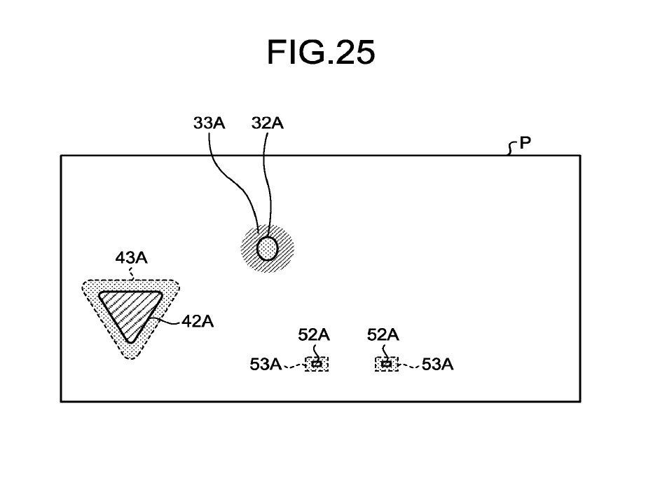

Specifically, the extraction unit 170G expands each of the traffic light candidate regions (the traffic light candidate region 32A, the traffic light candidate region 42A, and the traffic light candidate regions 52A) identified by the identification unit 170F. Thereby, the extraction unit 170G obtains expanded regions (an expanded region 33A, an expanded region 43A, and expanded regions 53A) resulting from the expansion of each of the traffic light candidate regions (the traffic light candidate region 32A, the traffic light candidate region 42A, and the traffic light candidate regions 52A) (see FIG. 25).

Specifically, the extraction unit 170G obtains, as the expanded region 33A: the traffic light candidate region 32A; and a predetermined number of pixels continuous with an outer periphery of the traffic light candidate region 32A outward from the outer periphery. Similarly, the extraction unit 170G obtains, as the expanded region 43A: the traffic light candidate region 42A; and a predetermined number of pixels continuous with an outer periphery of the traffic light candidate region 42A outward from the outer periphery. Similarly, the extraction unit 170G obtains, as the expanded region 53A: the traffic light candidate region 52A; and a predetermined number of pixels continuous with an outer periphery of the traffic light candidate region 52A outward from the outer periphery.

The extraction unit 170G then calculates a size of each of these expanded regions (the expanded region 33A, the expanded region 43A, and the expanded regions 53A). The extraction unit 170G may calculate, as the size of each of the expanded regions, the number of pixels constituting the expanded region, or an area of the expanded region in the captured image P.

For example, the extraction unit 170G identifies, for each of the respective expanded regions (the expanded region 33A, the expanded region 43A, and the expanded regions 53A), pixels, which represent a range of color values indicated by the traffic light recognition dictionary 18C corresponding to the image capturing time zone selected by the selecting unit 16C, and which are continuous, from a pixel positioned at the center of the expanded region toward a circumference of the expanded region. The extraction unit 170G then calculates, as the size of each of the expanded regions, the number of identified pixels, or an area represented by a group of the identified pixels.

Upon calculation of the size of the expanded region, the extraction unit 170G may identify, instead of the range of color values indicated by the traffic light recognition dictionary 18C corresponding to the image capturing time zone selected by the selecting unit 16C, a range narrower than the range of the color values, or pixels of a range larger than the range of the color values.

The extraction unit 170G then identifies the expanded region 33A having a size in a predetermined range, from these expanded regions (the expanded region 33A, the expanded region 43A, and the expanded regions 53A). The extraction unit 170G then extracts the traffic light candidate region 32A of the identified expanded region 33A as a detection target. Thus, of the expanded regions (the expanded region 33A, the expanded region 43A, and the expanded regions 53A), the expanded regions (the expanded region 43A and the expanded regions 53A) each having a size larger than the predetermined range or a size smaller than the predetermined range are excluded from being a detection target.

This predetermined range may be any size (area or number of pixels) that enables the region 31A representing the light 30A to be selectively identified. An image capturing magnification of a captured image P captured by the image capturing device 12 is fixed.

The information processing apparatus 11A may measure, beforehand, a range of the size that the expanded region expanded by the predetermined number of pixels from the region 31A representing the light 30A included in the captured image P of the image capturing magnification may take, and store the range in the storage unit 18 beforehand. The extraction unit 170G then may extract, using the range of the size stored in the storage unit 18, the traffic light candidate region 32A of the expanded region 33A having the size in the predetermined range.

The image capturing magnification of the captured image P may be variable. If the image capturing magnification is variable, the information processing apparatus 11A may store image capturing magnifications and ranges of the size in association with each other in the storage unit 18 beforehand. The extraction unit 170G may read, from the storage unit 18, the range of the size corresponding to the image capturing magnification of the captured image P, and use the range in extracting the traffic light candidate region 32A.

Thereby, the extraction unit 170G extracts the traffic light candidate region 32A representing the light 30A of the traffic light 30, from the plural traffic light candidate regions (the traffic light candidate region 32A, the traffic light candidate region 42A, and the traffic light candidate regions 52A) included in the captured image P.

Therefore, the extraction unit 170G is able to exclude, from the plural traffic light candidate regions included in the captured image P, regions other than the traffic light (for example, the regions of the lamps 50A, such as tail lamps of the vehicle 50, and a region of a signboard or a traffic sign (for example, the region of the traffic sign 40)) from being detection targets. In detail, for example, if the image capturing time zone is the daytime, a region, such as the region of the traffic sign 40 that is larger than the traffic light 30, is able to be excluded from being a detection target. Further, for example, if the image capturing time zone is the nighttime, a region, such as the region of a street lamp or a tail lamp of the vehicle 50, is able to be excluded from being a detection target.

The recognition unit 170H recognizes the traffic light region 34A, based on the traffic light candidate region 32A extracted by the extraction unit 170G (see FIG. 14 and FIG. 18). The recognition unit 170H may recognize the traffic light region 34A similarly to the recognition unit 16G of the first embodiment, except for the recognition of the traffic light region 34A by use of the traffic light candidate region 32A extracted by the extraction unit 170G from the traffic light candidate regions (the traffic light candidate region 32A, the traffic light candidate region 42A, and the traffic light candidate regions 52A) included in the captured image P (see FIG. 14 and FIG. 18).

As described above, in this embodiment, the detecting unit 170D detects, from the captured image P, the traffic light color identified by the identification unit 16F, and the traffic light region 34A recognized by the recognition unit 16G (see FIG. 14 and FIG. 18).

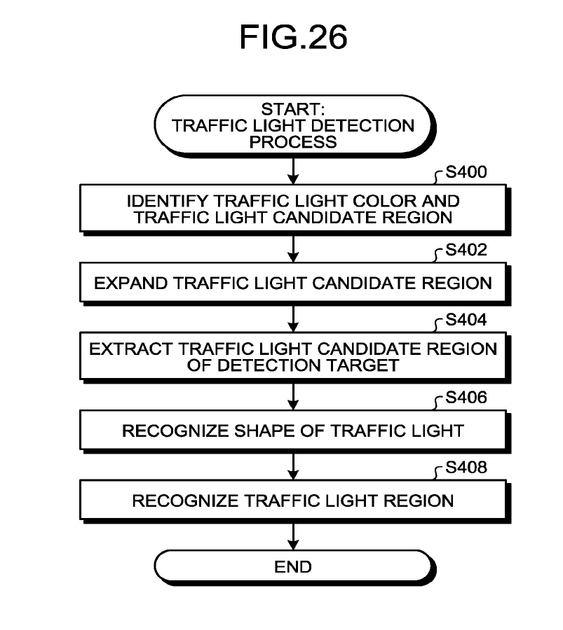

Next, an example of a procedure of information processing executed by the information processing apparatus 11A of this embodiment will be described. The procedure of the information processing executed by the information processing apparatus 11A is similar to the procedure of the information processing of the first embodiment described by use of FIG. 19. However, the information processing apparatus 11A of this embodiment executes processing illustrated in FIG. 26 in the detection process at Step S106 in FIG. 19.

A procedure of the detection process (Step S106 in FIG. 19) of this embodiment will be described. FIG. 26 is a flow chart illustrating an example of the procedure of the detection process executed by the detecting unit 170D of this embodiment.

Firstly, the identification unit 170F of the detecting unit 170D identifies traffic light candidate regions and traffic light colors in the captured image P acquired in Step S100 (see FIG. 19), using the traffic light recognition dictionary 18C selected by the selecting unit 16C in Step S104 (see FIG. 19) (Step S400).

Next, the extraction unit 170G of the detecting unit 170D expands the traffic light candidate regions (Step S402). Thereby, the extraction unit 170G obtains expanded regions resulting from the expansion of the traffic light candidate regions.

Next, the extraction unit 170G of the detecting unit 170D identifies an expanded region having a size that is in a predetermined range, from the expanded regions obtained in Step S402. The extraction unit 170G then extracts the traffic light candidate region 32A of the identified expanded region 33A, as a detection target (Step S404).

Next, the recognition unit 170H executes Hough conversion of the expanded region extracted in Step S404, and determines whether or not a circular stereotype region is able to be extracted from the expanded region (Step S406). If the stereotype region is able to be extracted, the recognition unit 170H recognizes, as the traffic light region 34A, a rectangular region circumscribing the stereotype region (Step S408). This routine is then ended.

As described above, in the information processing apparatus 11A of this embodiment, the detecting unit 170D includes the identification unit 170F, the extraction unit 170G, and the recognition unit 170H. The identification unit 170F identifies, as a traffic light candidate region (the traffic light candidate region 32A, the traffic light candidate region 42A, or the traffic light candidate region 52A), a region belonging to a range of color values of a reference traffic light color indicated by the selected traffic light recognition dictionary 18C, and identifies, as a traffic light color, the reference traffic light color of a type corresponding to color values of the traffic light candidate region. The extraction unit 170G extracts, from the traffic light candidate regions identified by the identification unit 170F, a detection target, which is a traffic light candidate region (the traffic light candidate region 32A) having a size in a predetermined range when expanded into an expanded region (the expanded region 33A, the expanded region 43A, or the expanded region 53A) expanded from the traffic light candidate region. The recognition unit 170H recognizes, based on the extracted traffic light candidate region 32A, the traffic light region 34A.

As described above, in the information processing apparatus 11A of this embodiment, the extraction unit 170G extracts, from the traffic light candidate regions identified by the identification unit 170F (the traffic light candidate region 32A, the traffic light candidate region 42A, and the traffic light candidate regions 52A), a detection target, which is a traffic light candidate region having a size in a predetermined range when expanded into an expanded region expanded from the traffic light candidate region. Thereby, the extraction unit 170G extracts the traffic light candidate region 32A representing the light 30A of the traffic light 30, from the plural traffic light candidate regions (the traffic light candidate region 32A, the traffic light candidate region 42A, and the traffic light candidate regions 52A) included in the captured image P. The detecting unit 170D then detects, using the extracted traffic light candidate region 32A, the traffic light region 34A.

Therefore, the information processing apparatus 11A of this embodiment is able to detect the traffic light region 34A and the traffic light color of the traffic light 30 even more accurately, in addition to achieving the effects of the above described information processing apparatus 10 of the first embodiment.

### Third Embodiment

In this embodiment, a subject other than the traffic light 30 included in a captured image P being misrecognized as a traffic light region (the traffic light region 34A) is prevented, in a mode different from the second embodiment.

FIG. 1 is an explanatory diagram for an example of an information processing apparatus 11B of this embodiment. In this embodiment, similarly to the information processing apparatus 10 of the first embodiment, a mode where the information processing apparatus 11B has been installed in the vehicle 20 will be described as an example.

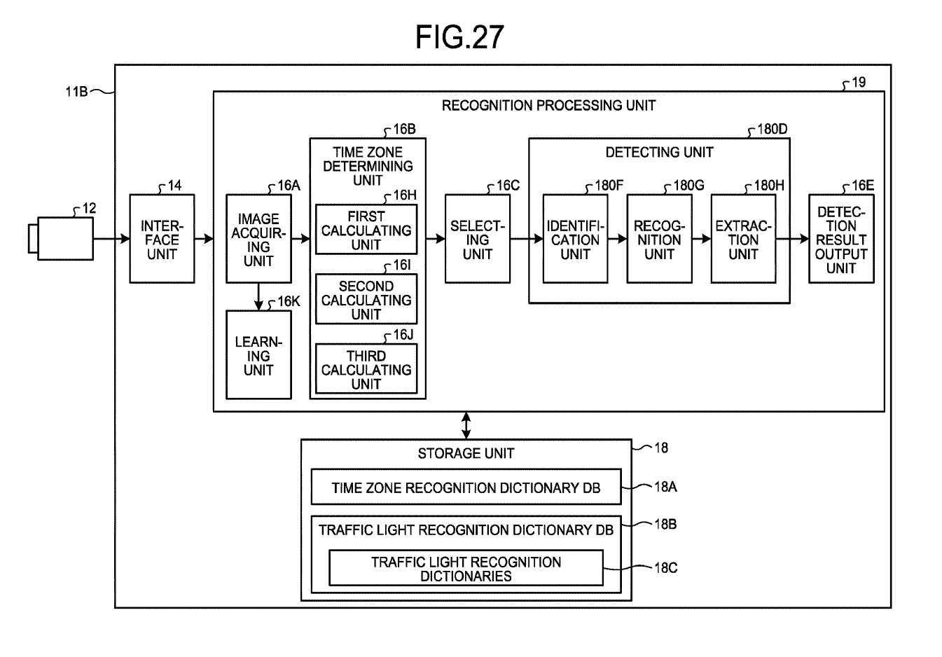

Next, a functional configuration of the information processing apparatus 11B will be described. FIG. 27 is a block diagram illustrating an example of the functional configuration of the information processing apparatus 11B. The information processing apparatus 11B includes the interface unit 14, a recognition processing unit 19, and the storage unit 18. The interface unit 14 and the storage unit 18 are electrically connected to the recognition processing unit 19.

The interface unit 14 and the storage unit 18 are the same as the first embodiment. That is, the information processing apparatus 11B is the same as the information processing apparatus 10 of the first embodiment, except for the inclusion of the recognition processing unit 19 instead of the recognition processing unit 16.

The recognition processing unit 19 includes the image acquiring unit 16A, the time zone determining unit 16B, the selecting unit 16C, a detecting unit 180D, the detection result output unit 16E, and the learning unit 16K. The recognition processing unit 19 is the same as the recognition processing unit 16 of the first embodiment, except for the inclusion of the detecting unit 180D instead of the detecting unit 16D.

Similarly to the detecting unit 16D of the first embodiment, the detecting unit 180D detects, based on the image capturing time zone determined by the time zone determining unit 16B, the traffic light region of the traffic light 30 and the traffic light color indicated by the traffic light 30, in the captured image P. That is, using the traffic light recognition dictionary 18C selected by the selecting unit 16C, the detecting unit 180D detects the traffic light region and the traffic light color.

The detecting unit 180D includes an identification unit 180F, a recognition unit 180G, and an extraction unit 180H.

The identification unit 180F is similar to the identification unit 16F of the first embodiment. That is, the identification unit 180F identifies, in the captured image P, a traffic light candidate region, which is a region belonging to a range of color values of the reference traffic light colors indicated by the traffic light recognition dictionary 18C selected by the selecting unit 16C. Further, the identification unit 180F identifies, as the traffic light color, the reference traffic light color of a type corresponding to color values of the traffic light candidate region.

The recognition unit 180G recognizes, based on the traffic light candidate region identified by the identification unit 180F, the traffic light region in the captured image P. Processing of the recognition unit 180G is similar to the recognition unit 16G of the first embodiment.

That is, the recognition unit 180G recognizes the traffic light region, which is a region including a predetermined stereotype region in the expanded region 33A resulting from expansion of the traffic light candidate region 32A.

As also described with respect to the second embodiment, the captured image P sometimes includes a subject indicating a color similar to a traffic light color of the traffic light 30. In this case, the recognition unit 180G may recognize the subject other than the traffic light 30 as a traffic light region.

Thus, in this embodiment, the extraction unit 180H extracts, as the traffic light region 34A of the traffic light 30 in the captured image P, a traffic light region in a predetermined size range, from traffic light regions recognized by the recognition unit 180G.

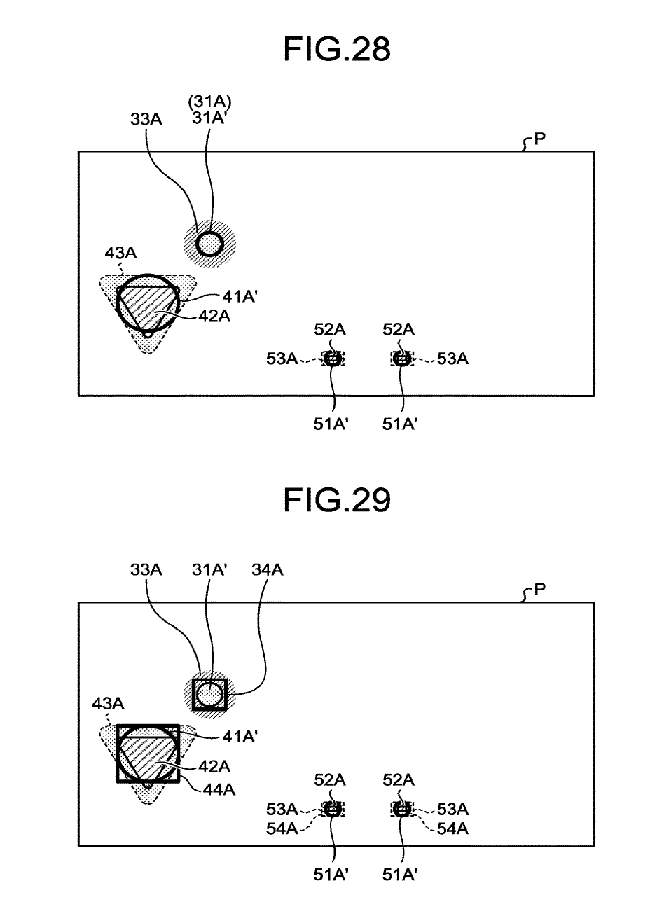

FIG. 28 and FIG. 29 are explanatory views for an example of a recognition process by the recognition unit 180G.

For example, it will be assumed that the captured image P is an image including plural types of subjects (see FIG. 23). Specifically, as illustrated in FIG. 23, the traffic light 30, and subjects (for example, the traffic sign 40, and the lamps 50A of the vehicle 50) indicating colors similar to a traffic light color of the traffic light 30 may be included in the captured image P.

In this case, by processing of the identification unit 180F and the recognition unit 180G, expanded regions (the expanded region 33A, the expanded region 43A, and the expanded regions 53A) resulting from expansion of each of traffic light candidate regions (the traffic light candidate region 32A, the traffic light candidate region 42A, and the traffic light candidate regions 52A) are obtained (see FIG. 28).

Similarly to the recognition unit 16G of the first embodiment, the recognition unit 180G then executes Hough conversion of each of the expanded regions (the expanded region 33A, the expanded region 43A, and the expanded regions 53A), and determines whether or not circular stereotype regions (a stereotype region 31A′, a stereotype region 41A′, and a stereotype region 51A′) are able to be extracted from the expanded regions (the expanded region 33A, the expanded region 43A, and the expanded regions 53A) (see FIG. 28). If the stereotype regions are able to be extracted, the recognition unit 180G recognizes regions including the stereotype regions (the stereotype region 31A′, the stereotype region 41A′, and the stereotype region 51A′) as the traffic light regions (the traffic light region 34A, a traffic light region 44A, and traffic light regions 54A) (see FIG. 29).

The extraction unit 180H extracts, as the traffic light region 34A of the traffic light 30 in the captured image P, the traffic light region 34A in a predetermined size range, from the traffic light regions (the traffic light region 34A, the traffic light region 44A, and the traffic light regions 54A) recognized by the recognition unit 180G. As the size of a traffic light region, the number of pixels constituting the traffic light region, or an area of the traffic light region in the captured image P may be used.

For example, the extraction unit 180H identifies, for each of the traffic light regions (the traffic light region 34A, the traffic light region 44A, and the traffic light regions 54A) recognized by the recognition unit 180G, pixels, which represent a range of color values indicated by the traffic light recognition dictionary 18C corresponding to the image capturing time zone selected by the selecting unit 16C, and which are continuous, toward a circumference of the traffic light region from a pixel positioned at the center of the traffic light region. Continuous pixels mean continuously arranged pixels. The number of pixels identified for each of the traffic light regions, or an area represented by a group of the identified pixels, is calculated as the size of the traffic light region.

Upon the calculation of the size of the traffic light region, the extraction unit 180H may identify, instead of the range of color values indicated by the traffic light recognition dictionary 18C corresponding to the image capturing time zone selected by the selecting unit 16C, a range narrow than the range of the color values, or pixels of a range larger than the range of the color values.

The extraction unit 180H then extracts, as the traffic light region 34A of the traffic light 30 in the captured image P, the traffic light region 34A having a size in a predetermined range, from these traffic light regions (the traffic light region 34A, the traffic light region 44A, and the traffic light regions 54A). Thus, of the traffic light regions (the traffic light region 34A, the traffic light region 44A, and the traffic light regions 54A), any traffic light region having a size larger than the predetermined range, or a size smaller than the predetermined range (the traffic light region 44A and the traffic light region 54A) is excluded from being a target to be extracted.

This predetermined size range may be any size (area or number of pixels) that enables the traffic light region 34A corresponding to the region 31A representing the light 30A to be selectively identified. The image capturing magnification of the captured image P captured by the image capturing device 12 is fixed.

The information processing apparatus 11B may measure, beforehand, a range of the size that the traffic light region 34A of the region 31A representing the light 30A included in the captured image P of the image capturing magnification may take, and store the range in the storage unit 18 beforehand. The extraction unit 180H then may extract, using the range of the size stored in the storage unit 18, the traffic light region 34A having the size in the predetermined range as the traffic light region 34A of the traffic light 30.

The image capturing magnification of the captured image P may be variable. In this case, the information processing apparatus 11B may store image capturing magnifications and ranges of the size in association with each other in the storage unit 18 beforehand. The extraction unit 180H may read the range of the size corresponding to the image capturing magnification of the captured image P and use the range in the extraction of the traffic light region 34A.

As described above, in this embodiment, the detecting unit 180D detects, from the captured image P, the identified color identified by the identification unit 180F, and the traffic light region 34A recognized by the recognition unit 180G and extracted by the extraction unit 180H (see FIG. 14 and FIG. 18).

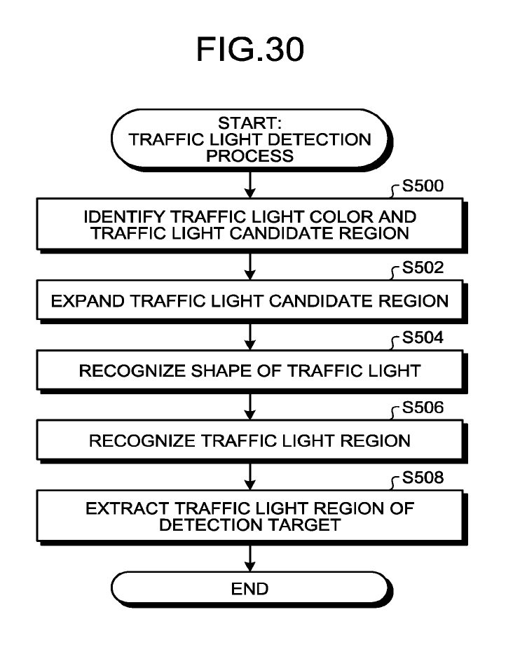

Next, an example of a procedure of information processing executed by the information processing apparatus 11B of this embodiment will be described. The procedure of the information processing executed by the information processing apparatus 11A is similar to the procedure of the information processing of the first embodiment described by use of FIG. 19. However, the information processing apparatus 11B of this embodiment executes processing illustrated in FIG. 30 in the detection process at Step S106 in FIG. 19.

A procedure of the detection process (Step S106 in FIG. 19) of this embodiment will be described. FIG. 30 is a flow chart illustrating an example of the procedure of the detection process executed by the detecting unit 180D of this embodiment.

Firstly, the identification unit 180F of the detecting unit 180D identifies traffic light candidate regions and traffic light colors of the regions in the captured image P acquired in Step S100 (see FIG. 19), using the traffic light recognition dictionary 18C selected by the selecting unit 16C in Step S104 (see FIG. 19) (Step S500).

Next, the recognition unit 180G of the detecting unit 180D expands the traffic light candidate regions (Step S502). Thereby, the recognition unit 180G obtains expanded regions resulting from the expansion of the traffic light candidate regions.

Next, the recognition unit 180G executes Hough conversion of the expanded regions, and determines whether or not circular stereotype regions are able to be extracted from the expanded regions (Step S504). If the circular stereotype regions are able to be extracted, the recognition unit 180G recognizes, as traffic light regions (the traffic light region 34A, the traffic light region 44A, and the traffic light regions 54A), rectangular regions circumscribing the stereotype regions (Step S506).

Next, the extraction unit 180H extracts, as the traffic light region 34A of the traffic light 30 in the captured image P, the traffic light region 34A in a predetermined size range, from the traffic light regions (the traffic light region 34A, the traffic light region 44A, and the traffic light regions 54A) recognized in Step S506 (Step S508). This routine is then ended.

As described above, in the information processing apparatus 11B of this embodiment, the detecting unit 180D includes the identification unit 180F, the extraction unit 180G, and the recognition unit 180H. The identification unit 180F identifies, in the captured image P, traffic light candidate regions (the traffic light candidate region 32A, the traffic light candidate region 42A, and the traffic light candidate regions 52A), each of which is an region belonging to a range of color values of a reference traffic light color indicated by the selected traffic light recognition dictionary 18C, and identifies, as traffic light colors, the reference traffic light colors of types corresponding to color values of the traffic light candidate regions.

The recognition unit 180G recognizes, based on the identified traffic light candidate regions (the traffic light candidate region 32A, the traffic light candidate region 42A, and the traffic light candidate regions 52A), the traffic light regions (the traffic light region 34A, the traffic light region 44A, and the traffic light regions 54A). The extraction unit 180H extracts, as the traffic light region 34A of the traffic light 30 in the captured image P, the traffic light region 34A in a predetermined size range, from the traffic light regions (the traffic light region 34A, the traffic light region 44A, and the traffic light regions 54A) recognized by the recognition unit 180G. The detecting unit 180D detects the identified traffic light color and the recognized and extracted traffic light region 34A.

As described above, in the information processing apparatus 11B of this embodiment, the extracting unit 180H extracts, as the traffic light region 34A of the traffic light 30 in the captured image P, the traffic light region 34A in the predetermined size range, from the traffic light regions (the traffic light region 34A, the traffic light region 44A, and the traffic light regions 54A) recognized by the recognition unit 180G. The detecting unit 180D detects the identified traffic light color and the recognized and extracted traffic light region 34A.

Thereby, the extraction unit 180H extracts the traffic light region 34A representing the light 30A of the traffic light 30, from the traffic light regions recognized by the recognition unit 180, the traffic light regions being included in the captured image P. The detecting unit 180D then detects the identified traffic light color and the recognized and extracted traffic light region 34A.

Therefore, the information processing apparatus 11B of this embodiment is able to detect the traffic light region 34A and the traffic light color of the traffic light 30 even more accurately, in addition to achieving the effects of the above described information processing apparatus 10 of the first embodiment.

Modification

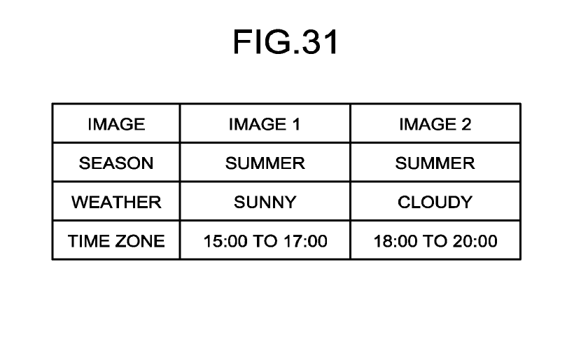

Instead of just the time zone, an image capturing environment may also be recognized. Depending on the image capturing environment identified based on, for example, the image capturing season, weather, and more detailed time zone as illustrated in a table of FIG. 31, brightness and contrast of the image change. By a method similar to the above described machine learning method of recognizing the image capturing time zone, the image capturing environment is able to be recognized also. That is, by captured images being collected in each image capturing environment, image capturing environment recognition dictionaries are able to be generated.

According to a result of the recognition of the image capturing environment, a traffic light recognition dictionary and recognition parameters corresponding to the image capturing environment are input. Thereby, an optimum recognition process can be executed.

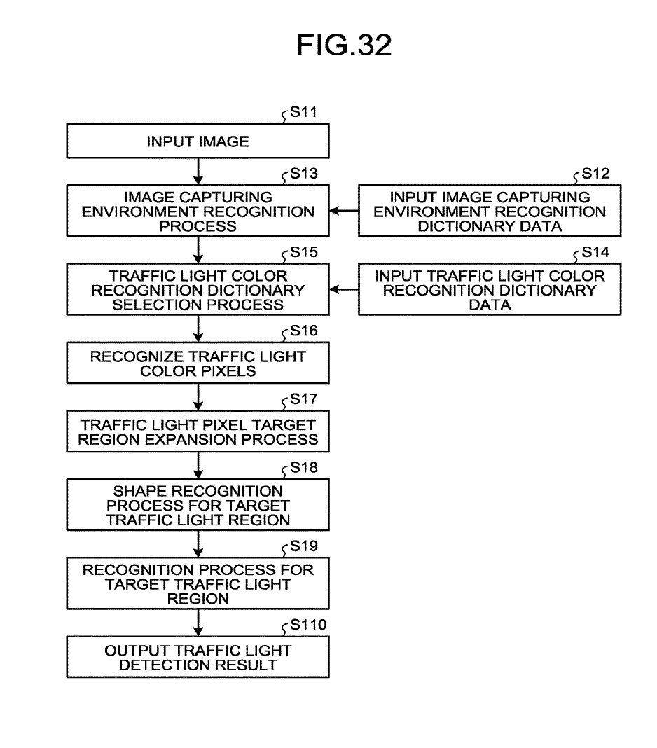

FIG. 32 illustrates an example of a flow of a traffic light recognition process using the recognition of the image capturing environment. In the traffic light recognition process, a captured image is input at step S11. Based on image capturing environment recognition dictionary data, which can be generated in a manner similar to the time zone recognition dictionary 18A and input at step S12, image capturing environment recognition process, which can be performed in a manner similar to the process at step S102, is performed at step S13. Using the traffic light color recognition dictionary data, which can be generated in a manner similar to the traffic light recognition dictionary DB 18B and input at step S14, traffic light color recognition dictionary selection process, which can be performed in a manner similar to the process at step S104, is performed at step S15 based on the image capturing environment recognized at step S13. At step S16, traffic light color pixels are recognized in a manner similar to the process at step S300 using the traffic light color recognition dictionary selected at step S15. Traffic light pixel target region expansion process, which can be performed in a manner similar to the process at step S302, is performed at step S17. Shape recognition process for the target traffic light region, which can be performed in a manner similar to the process at step S304, is performed at step S18. Recognition process for the target traffic light region, which can be performed in a manner similar to the process at step S306, is performed at step S19. Then traffic light detection result is output similarly to the process at step S108.

Further, in the above embodiments, the modes where the information processing apparatus 10, the information processing apparatus 11A, and the information processing apparatus 11B have been respectively installed in the vehicle 20 have been described. However, modes may be adopted, where the information processing apparatus 10, the information processing apparatus 11A, and the information processing apparatus 11B are configured as separate bodies from the vehicle 20 and not installed in the vehicle 20. That is, each of the information processing apparatus 10, the information processing apparatus 11A, and the information processing apparatus 11B may be configured to be applied to a known personal computer (PC).

In this case, plural captured images P captured by the image capturing device 12 installed in the vehicle 20 may be stored in a known storage medium (for example, a memory card) or the storage unit 18, beforehand.

Each of the information processing apparatus 10, the information processing apparatus 11A, and the information processing apparatus 11B may detect the traffic light region 34A and the traffic light color, similarly to the above described embodiments, for each of the captured images P stored in the storage medium or the storage unit 18.

In this case, each of the information processing apparatus 10, the information processing apparatus 11A, and the information processing apparatus 11B, which is, for example, a personal computer (PC), is able to detect the traffic light region 34A and the traffic light color from the captured image P.

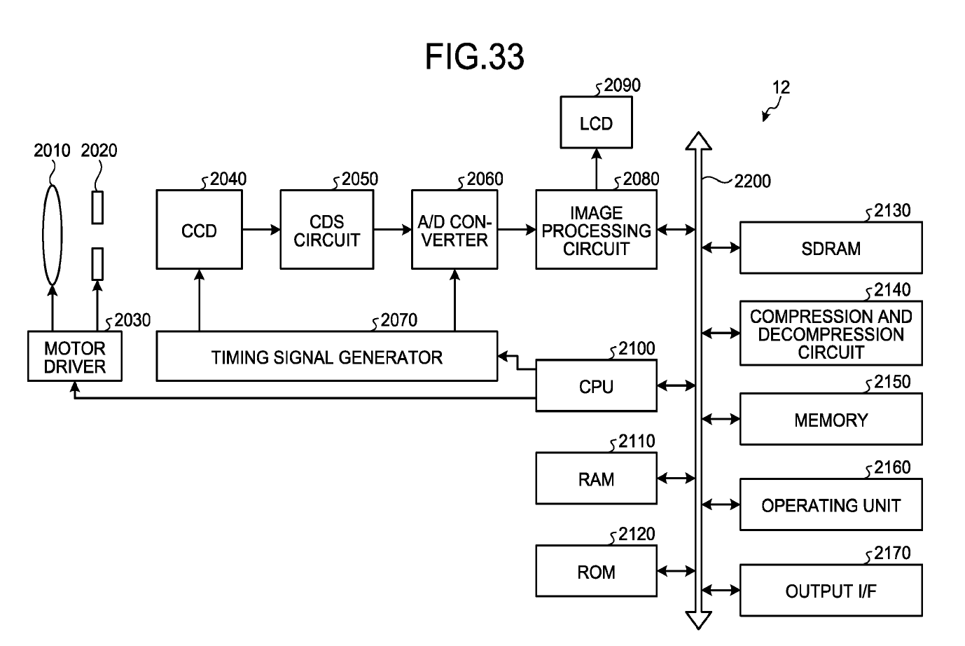

Next, an example of a hardware configuration of the image capturing device 12 will be described. FIG. 33 is a diagram illustrating the example of the hardware configuration of the image capturing device 12.

The image capturing device 12 includes an image capturing optical system 2010, a mechanical shutter 2020, a motor driver 2030, a charge coupled device (CCD) 2040, a correlated double sampling (CDS) circuit 2050, an A/D converter 2060, a timing signal generator 2070, an image processing circuit 2080, a liquid crystal display (LCD) 2090, a central processing unit (CPU) 2100, a random access memory (RAM) 2110, a read only memory (ROM) 2120, a synchronous dynamic random access memory (SDRAM) 2130, a compression and decompression circuit 2140, a memory 2150, an operating unit 2160, and an output I/F 2170.

The image processing circuit 2080, the CPU 2100, the RAM 2110, the ROM 2120, the SDRAM 2130, the compression and decompression circuit 2140, the memory 2150, the operating unit 2160, and the output I/F 2170 are connected to one another via a bus 2200.

The image capturing optical system 2010 condenses reflected light from a subject. The mechanical shutter 2020 is open for a predetermined time period to cause the light condensed by the image capturing optical system 2010 to be incident on the CCD 2040. The motor driver 2030 drives the image capturing optical system 2010 and the mechanical shutter 2020.

The CCD 2040 images the light incident via the mechanical shutter 2020 as an image of the subject, and inputs analog image data representing the image of the subject into the CDS circuit 2050.

When the CDS circuit 2050 receives the analog image data from the CCD 2040, the CDS circuit 2050 removes a noise component from the image data. Further, the CDS circuit 2050 executes analog processing, such as correlated double sampling and gain control. The CDS circuit 2050 then outputs the processed analog image data to the A/D converter 2060.

When the A/D converter 2060 receives the analog image data from the CDS circuit 2050, the A/D converter 2060 converts the analog image data to digital image data. The A/D converter 2060 inputs the digital image data into the image processing circuit 2080. According to a control signal from the CPU 2100, the timing signal generator 2070 transmits timing signals to the CCD 2040, the CDS circuit 2050, and the A/D converter 2060 to control operation timings of the CCD 2040, the CDS circuit 2050, and the A/D converter 2060.

When the image processing circuit 2080 receives the digital image data from the A/D converter 2060, the image processing circuit 2080 executes image processing on the digital image data using the SDRAM 2130. The image processing includes, for example, CrCb conversion processing, white balance control processing, contrast correction processing, edge enhancement processing, and color conversion processing.

The image processing circuit 2080 outputs the image data that have been subjected to the above described image processing to the LCD 2090, or the compression and decompression circuit 2140. The LCD 2090 is a liquid crystal display that displays thereon the image data received from the image processing circuit 2080.

When the compression and decompression circuit 2140 receives the image data from the image processing circuit 208, the compression and decompression circuit 2140 compresses the image data. The compression and decompression circuit 2140 stores the compressed image data in the memory 2150. Further, when the compression and decompression circuit 2140 receives the image data from the memory 2150, the compression and decompression circuit 2140 decompresses the image data. The compression and decompression circuit 2140 temporarily stores the decompressed image data in the SDRAM 213. The memory 2150 stores therein the compressed image data.

The output I/F 2170 outputs the image data processed by the image processing circuit 2080, as the captured image P, to the information processing apparatus 10, the information processing apparatus 11A, or the information processing apparatus 11B.

At least a part of the functional units included in the interface unit 14 and the recognition processing unit 16 described above with respect to each of FIG. 2, FIG. 22, and FIG. 27 may be mounted in the image capturing device 12 as a signal processing board (signal processing circuit).

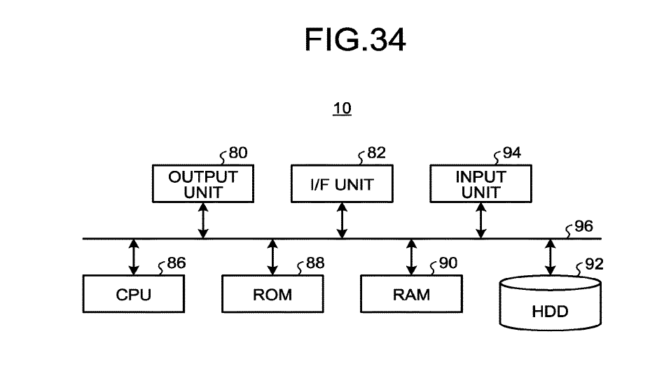

Next, a hardware configuration of each of the information processing apparatus 10, the information processing apparatus 11A, and the information processing apparatus 11B according to the above described embodiments and modification will be described. FIG. 34 is a block diagram illustrating an example of the hardware configuration of each of the information processing apparatus 10, the information processing apparatus 11A, and the information processing apparatus 11B according to the above described embodiments and modification.

Each of the information processing apparatus 10, the information processing apparatus 11A, and the information processing apparatus 11B according to the above described embodiments and modification includes an output unit 80, an I/F unit 82, and input unit 94, a CPU 86, a read only memory (ROM) 88, a random access memory (RAM) 90, an HDD 92, and the like, which are mutually connected via a bus 96, and has a hardware configuration using a normal computer.

The CPU 86 is an arithmetic unit that controls processing executed by each of the information processing apparatus 10, the information processing apparatus 11A, and the information processing apparatus 11B according to the above described embodiments and modification. The RAM 90 stores therein data needed for various types of processing by the CPU 86. The ROM 88 stores therein a program and the like that realize the various types of processing by the CPU 86. The HDD 92 stores therein the data stored in the above described storage unit 18. The I/F unit 82 is an interface for transmission and reception of data to and from another device.

The program for execution of the above described various types of processing executed by each of the information processing apparatus 10, the information processing apparatus 11A, or the information processing apparatus 11B according to the above described embodiments and modification is provided by being incorporated in the ROM 88 or the like beforehand.

The program executed by each of the information processing apparatus 10, the information processing apparatus 11A, and the information processing apparatus 11B according to the above described embodiments and modification may be configured to be provided by being recorded in a computer readable recording medium, such as a CD-ROM, a flexible disk (FD), or a digital versatile disk (DVD), as a file in a format installable in, or a format executable by the information processing apparatus 10, the information processing apparatus 11A, or the information processing apparatus 11B.

Further, the program executed by each of the information processing apparatus 10, the information processing apparatus 11A, and the information processing apparatus 11B according to the above described embodiments and modification may be configured to be provided by being stored on a computer connected to a network, such as the Internet, and being downloaded via the network. Furthermore, the program for execution of the processing by each of the information processing apparatus 10, the information processing apparatus 11A, and the information processing apparatus 11B according to the above described embodiments and modification may be configured to be provided or distributed via a network, such as the Internet.

The program for execution of the above described various types of processing executed by each of the information processing apparatus 10, the information processing apparatus 11A, and the information processing apparatus 11B according to the above described embodiments and modification is configured such that each of the above described units is generated on the main storage device.

Various pieces of information stored in the HDD 92 may be stored in an external device. In this case, the external device and the CPU 86 may be configured to be connected to each other via a network or the like.

According to an embodiment, an effect that a traffic light region and a traffic light color of a traffic light can be accurately detected from a captured image is achieved.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

The method steps, processes, or operations described herein are not to be construed as necessarily requiring their performance in the particular order discussed or illustrated, unless specifically identified as an order of performance or clearly identified through the context. It is also to be understood that additional or alternative steps may be employed.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. An information processing apparatus comprising:
an image acquiring unit configured to acquire a captured image;
a time zone determining unit configured to determine an image capturing time zone of the captured image; and
a detecting unit configured to detect, based on the determined image capturing time zone, a traffic light region of a traffic light in the captured image and a traffic light color indicated by the traffic light.

2. The information processing apparatus according to claim 1, wherein
the time zone determining unit includes:
a first calculating unit configured to calculate an average brightness of the captured image; and
a second calculating unit configured to divide the captured image into a plurality of blocks, and calculate a small brightness block number that is a number of blocks each having an average brightness equal to or less than a threshold, and
the time zone determining unit is configured to determine the image capturing time zone, based on feature amounts including the average brightness of the captured image and the small brightness block number.

3. The information processing apparatus according to claim 1, wherein
the time zone determining unit includes:
a first calculating unit configured to calculate an average brightness of the captured image;
a second calculating unit configured to divide the captured image into a plurality of blocks, and calculate a small brightness block number that is a number of blocks each having an average brightness equal to or less than a threshold; and
a third calculating unit configured to calculate a variance of the average brightnesses of the respective blocks in the captured image, and
the time zone determining unit is configured to determine the image capturing time zone, based on feature amounts including the average brightness of the captured image, the small brightness block number, and the variance.

4. The information processing apparatus according to claim 1, wherein the time zone determining unit is configured to determine that the image capturing time zone of the captured image represents daytime or nighttime.

5. The information processing apparatus according to claim 1, further comprising:
a selecting unit configured to select a traffic light recognition dictionary corresponding to the determined image capturing time zone, wherein
the detecting unit is configured to detect the traffic light region and the traffic light color, using the selected traffic light recognition dictionary.

6. The information processing apparatus according to claim 5, wherein
each traffic light recognition dictionary indicates a range of a color value corresponding to one of a plurality of types of reference traffic light colors indicated by the traffic light included in a reference captured image captured in a corresponding image capturing time zone,
the detecting unit includes:
an identification unit configured to identify at least one traffic light candidate region that is a region belonging to a range of a color value of a reference traffic light color indicated by the selected traffic light recognition dictionary, and identify, as a traffic light color, a type of the reference traffic light color corresponding to the color value of the at least one traffic light candidate region; and
a recognition unit configured to recognize the traffic light region, based on the at least one traffic light candidate region, and
the detecting unit is configured to detect the identified traffic light color and the recognized traffic light region.

7. The information processing apparatus according to claim 6, wherein a traffic light recognition dictionary corresponding to an image capturing time zone representing nighttime indicates a range of a color value of a peripheral region around a region representing a light of the traffic light in a reference captured image captured in the image capturing time zone representing the nighttime.

8. The information processing apparatus according to claim 6, wherein a traffic light recognition dictionary corresponding to an image capturing time zone representing daytime indicates a range of a color value of a region representing a light of the traffic light in a reference captured image captured in the image capturing time zone representing the daytime.

9. The information processing apparatus according to claim 6, wherein the recognition unit is configured to, if a stereotype region having a predetermined shape is included in an expanded region resulting from expansion of an identified traffic light candidate region, recognize the region including the stereotype region as the traffic light region.

10. The information processing apparatus according to claim 9, wherein the recognition unit is configured to, if the stereotype region that is circular is included in the expanded region, recognize the region including the stereotype region as the traffic light region.

11. The information processing apparatus according to claim 6, wherein
the detecting unit includes an extraction unit configured to extract, from the at least one traffic light candidate region identified by the identification unit, a traffic light candidate region as a detection target such that an expanded region resulting from expansion of the traffic light candidate region has a size in a predetermined range, and
the recognition unit is configured to recognize the traffic light region, based on the extracted traffic light candidate region.

12. The information processing apparatus according to claim 6, wherein
the detecting unit includes an extraction unit configured to extract, from the traffic light region recognized by the recognition unit, the traffic light region in a predetermined size range as the traffic light region of the traffic light in the captured image, and
the detecting unit is configured to detect the identified traffic light color and the recognized and extracted traffic light region.

13. An information processing method comprising:
acquiring a captured image;
determining an image capturing time zone of the captured image; and
detecting, based on the determined image capturing time zone, a traffic light region of a traffic light in the captured image and a traffic light color indicated by the traffic light.

14. A non-transitory computer-readable recording medium including an information processing program that causes a computer to execute:
acquiring a captured image;
determining an image capturing time zone of the captured image; and
detecting, based on the determined image capturing time zone, a traffic light region of a traffic light in the captured image and a traffic light color indicated by the traffic light.
